(19) United States
(12) Patent Application Publication
(10) Pub. No.: US 2017/0161372 A1
(43) Pub. Date: Jun. 8, 2017

(54) METHOD AND SYSTEM FOR SUMMARIZING EMAILS AND EXTRACTING TASKS

(71) Applicant: Codeq LLC, Apex, NC (US)

(72) Inventors: Paulo Malvar FERNÁNDEZ, La Mesa, CA (US); Douglas Dane BAKER, Cary, NC (US); Muhammad ABDUL-MAGEED, Bloomington, IN (US); Rodrigo ALARCÓN, Leipzig (DE); David SCHUELER, South Plainfield, NJ (US); Steven DeROSE, Silver Spring, MD (US)

(21) Appl. No.: 14/959,331

(22) Filed: Dec. 4, 2015

(51) Int. Cl. G06F 17/30; G06F 17/21; G06F 17/27

(52) U.S. Cl. CPC G06F 17/30705; G06F 17/30719; G06F 17/30675; G06F 17/2705; G06F 17/277; G06F 17/218; G06F 17/278; G06F 17/2755

(57) ABSTRACT

The disclosed invention performs a set of operations on an email to analyze the text and generate a coherent summary. Email summaries are generated by applying a coherence layer after a ranking process. Analyzing how sentences relate to each other via discourse markers and other linguistic devices aids in enhancing coherence of the email summaries. Output summaries are more coherent and easier to understand because they mimic the flow of ideas contained in the original message instead of merely being a collection of extracted sentences. Tasks may also be extracted from the text of the email to assist users in keeping track of tasks that they receive via email.

### FIELD OF THE INVENTION

The field of the present invention relates generally to natural language processing of email communications for the purpose of summarizing and extracting tasks from emails.

### BACKGROUND

A computer's attempts to understand and interpret human (i.e., natural) language, whether written or oral, is referred to as natural language processing. Natural language processing (NLP) involves linguistics, computer science, and artificial intelligence. Recent natural language processing algorithms are based on machine learning, especially statistical machine learning. Some implementations of language-processing tasks involve the direct hand-coding of large sets of rules. Other implementations that rely on machine-learning use general learning algorithms that are typically based on statistical inference to automatically learn interpretational rules through the analysis of a large “corpora” of typical real-world examples. As used herein, a corpus (or “corpora” plural) is a set of documents (or a collection of sentences).

Statistical inferences in machine learning make probabilistic decisions when interpreting natural language. Such probabilistic decisions provide several interpretations with different weights rather than a single interpretation that results from a series of if-then rules. Statistical inferences, therefore, can be said to make “soft” interpretational decisions as opposed to “hard” true-false, binary-type decisions that are the result of decision trees.

Conventional natural language processing techniques, however, inadequately leverage the coherence of a discourse. While natural language processing may accurately interpret one or two sentences strung together, conventional techniques are unable to identify how several sentences or expressions of multiple sentiments are connected together for the purpose of creating a coherent summary of a collection of several sentences over time, such as a sequence of emails in an email chain over a period of time. Aspects of the disclosed invention address such shortcomings.

### SUMMARY OF THE INVENTION

Systems, methods, and computer-readable media for summarizing emails and extracting tasks from emails are disclosed.

In one aspect, a method includes parsing, by an email zone identifier module, different zones in which an email is organized; processing text within the email, the processing comprising: tokenizing the text; lemmatizing the text; tagging the text with parts of speech; analyzing syntactic dependencies within the text; and extracting named entities; classifying, by a speech act classifier module, each sentence of the text into one of a plurality of speech acts; classifying, by a questions classifier module, sentences of the text that contain a question; summarizing, by a conversational email summarizer module, the email into a compact and coherent summary, the summarizing comprising: ranking each sentence in the text with an importance score, and adding sentences to an initial email summary that have an importance score surpassing a threshold; and applying a set of post-processing rules to sentences in the initial email summary after ranking each sentence in the text to yield a final email summary; and outputting the final email summary of the email.

Other embodiments of this aspect include corresponding systems, apparatus, and computer programs, configured to perform the actions of the methods, encoded on computer storage devices.

The details of embodiments of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts a block diagram of a system for sending data through a network, according to an exemplary embodiment;

FIG. 2 depicts a block diagram of an exemplary email mining platform and associated modules and email database(s), according to an exemplary embodiment;

FIG. 3 depicts a flow diagram of an exemplary email summarization and task extraction process, according to an exemplary embodiment of the invention;

FIG. 4 depicts a block diagram of an exemplary speech act classifier module, according to an exemplary embodiment of the invention;

FIG. 5 depicts a sequence diagram showing an exemplary interaction between various modules, according to an exemplary embodiment of the invention;

FIG. 6 depicts an exemplary output of an email summary, according to an exemplary embodiment of the invention;

FIG. 7 depicts an exemplary graphical user interface where a user can grant permission to access the user's email by the email mining platform, according to an exemplary embodiment of the invention;

### DETAILED DESCRIPTION OF THE INVENTION

Natural language processing according to exemplary embodiments of the invention involves email mining for the purpose of email classification, information extraction, and email summarization. Email can be classified into two main categories: conversational email and “botmail.” Conversational email is email written by a person for another person or persons, such as family, friends, co-workers, or even the original author of the email. Botmail is email that is auto-generated by companies, is generally unsolicited and commercial in nature, and is sent in an identical or nearly synonymous form to several people for promotional or other purposes.

Conversational email may be characterized as a human-produced text artifact that is free and asynchronous. Conversational email may be considered “free” because the content within the body of the email is produced as free text without limitations as to textual content, even though there may be some structural or grammatical conventions. And conversational email may be considered asynchronous because the interactions between the sender and receiver are not synchronized in time or space. Despite the free and asynchronous nature of conversational email, the exemplary embodiments disclosed herein are capable of classifying, extracting information from, and summarizing such emails.

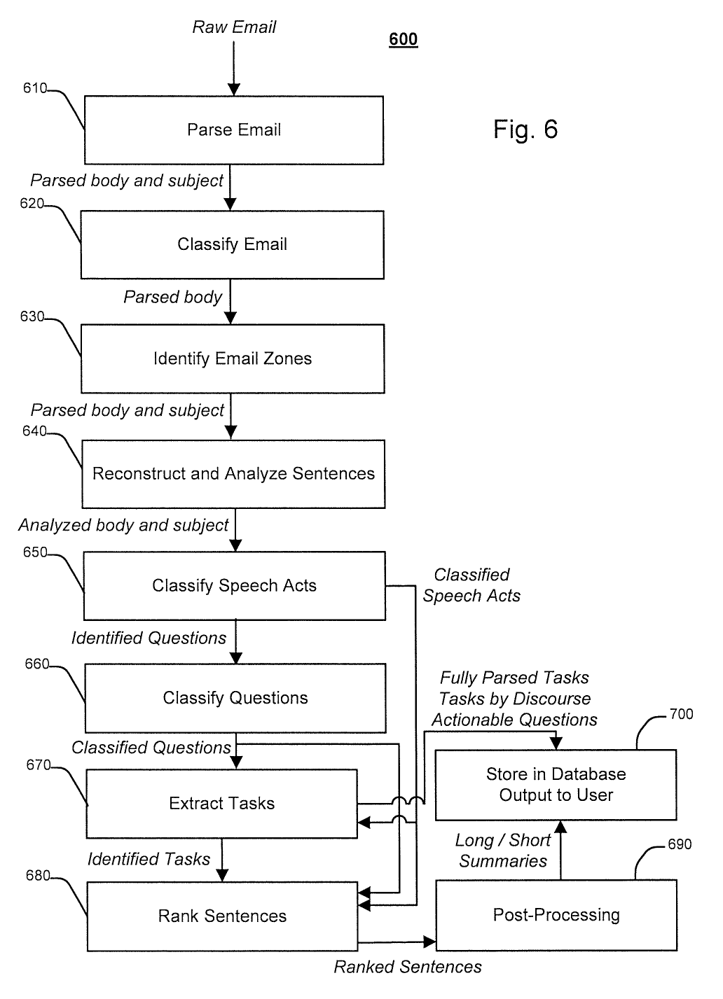

Such classification, information extraction, and summarization of conversational email simplifies a user's review and consumption of email. Output of the exemplary embodiments comprises one or more email summaries and tasks extracted from the email(s). An example email and exemplary output is shown in FIG. 6 and explained in further detail below. With such output, one is able to achieve faster, or even automated, responses and/or actions based on the email. Exemplary actions may include adding an event to a calendar, adding a contact to a contact list, or unsubscribing from an email distribution list, for example. Moreover, the exemplary disclosed embodiments also ease consumption of email on devices with small screens, such as smartphones, watches, computerized glasses, or heads up displays, for example. Further, a user's email inbox and/or task list can be “cleaned up” or established into an organized structure, which can aid the user in searching and consuming past emails or receiving and organizing future emails.

The description below of the exemplary email mining process and system describes modules that may include one or more servers, databases, subsystems and other components. As used herein, the term “module” may be understood to refer to non-transitory executable software, firmware, processor, hardware, and/or various combinations thereof. Modules, however, are not to be interpreted as software that is not implemented on hardware, firmware, or recorded on a tangible processor-readable or recordable storage medium (i.e., modules are not software per se). The modules are exemplary. The modules may be combined, integrated, separated, and/or duplicated to support various applications and may be centralized or distributed. A function described as being performed at a particular module may be performed at one or more other modules and/or by one or more other devices instead of or in addition to the function performed at the particular module. The modules may be implemented across multiple devices and/or other components local or remote to one another. The devices and components that comprise one module may or may not be distinct from the devices and components that comprise other modules.

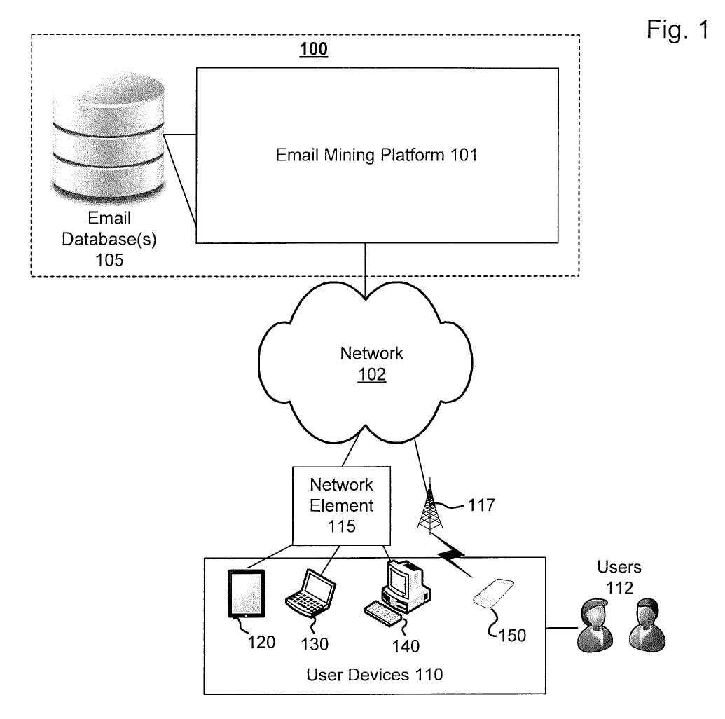

Referring to FIG. 1, a schematic diagram of a system 100 for mining email is shown, according to an exemplary embodiment. As illustrated, network 102 may be communicatively coupled with one or more data transmitting devices, network element(s) 115, or wireless transceiver(s) 117. System 100 may comprise the email mining platform 101, and email database(s) 105. Users 112 may access email mining platform 101 via network 102 using one or more user devices 120-150, for example. Additionally, email summaries and/or task lists may be sent to users via network 102.

Users 112 may access email mining platform 101 via network 102 using a user device 110. Exemplary user devices include a tablet computer 120, a laptop computer 130, a desktop computer 140, a mobile device 150, or other computer capable of sending or receiving network signals. Mobile device 150 may be a mobile communications device, a smartphone, a tablet computer, a wearable computer such as in the form of a watch or glasses, a health monitoring device, a home phone, a cellular phone, a mobile phone, a satellite phone, a personal digital assistant, a computer, a handheld multimedia device, a personal media player, a gaming device, a mobile television, or other devices capable of transmitting data and communicating directly or indirectly with network 102 or transceiver 117. Tablet computer 120, laptop computer 130, desktop computer 140, or mobile device 150 may connect to network 102 or transceiver 117 and communicate with other network elements, servers, platforms, or providers using a wired or wireless connection, and may utilize WiFi, 3G, 4G, LTE, Bluetooth, or other chipsets.

Network element 115 may transmit and receive data to and from network 102. The data may be transmitted and received utilizing a standard telecommunications protocol or a standard networking protocol. For example, data may be transmitted or received using Wireless Application Protocol (“WAP”), Multimedia Messaging Service (“MMS”), Enhanced Messaging Service (“EMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), Simple Mail Transfer Protocol (SMTP), Post Office Protocol (e.g., POP3), Internet Message Access Protocol (IMAP), Secure Shell (SSH) protocol, Microsoft® Exchange, MAPI, Exchange ActiveSync, a Short Message Service “SMS,” Session Initiation Protocol (“SIP”), Voice Over IP (“VoIP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

Network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support an Internet network, a wireless communication network, a cellular network, Bluetooth, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a government network, a cellular network, corporate networks, or home networks.

Transceiver 117 may be a repeater, a cellular tower, or another network access device capable of providing connectivity between different network mediums. Transceiver 117 may be capable of sending or receiving signals via a mobile network, a paging network, a cellular network, a satellite network or a radio network.

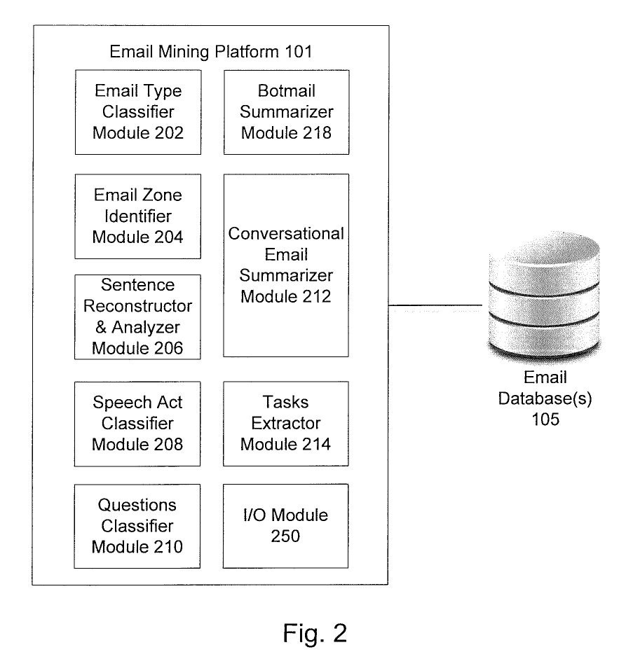

Referring to FIG. 2, exemplary modules of the email mining platform 101 are shown. The email mining platform may comprise an email type classifier module 202, an email zone identifier module 204, a sentence reconstructor & analyzer module 206, a speech act classifier module 208, a questions classifier module 210, a conversational email summarizer module 212, a tasks extractor module 214, an input/output (I/O) module 250, and a botmail summarizer module 218, for example. Each of these exemplary modules may have their own memory, processor, I/O interface, etc., as described above with respect to the modules described herein. The email mining platform 101 may retrieve and/or store data in email database 105. Exemplary data that email mining platform 101 may store in email database 105 includes user emails, summaries of user emails, tasks lists extracted from one or more user emails, and data generated by the various modules that make up the email mining platform 101, for example. Other data may also be stored in email database 105, such as user and/or user device information. User information may comprise a user profile, user login information, or user contact information, for example.

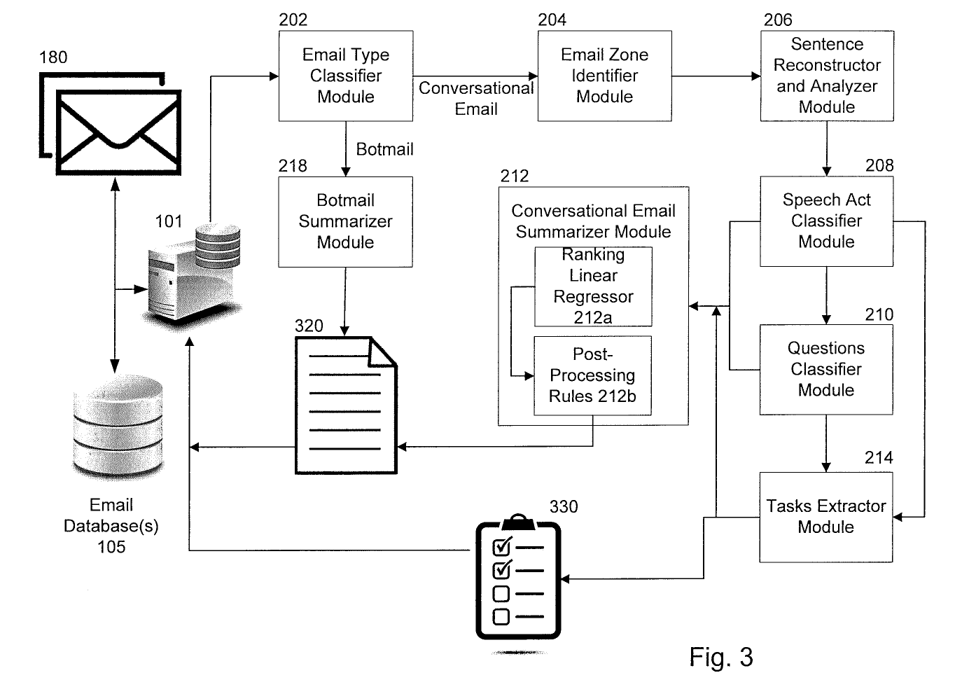

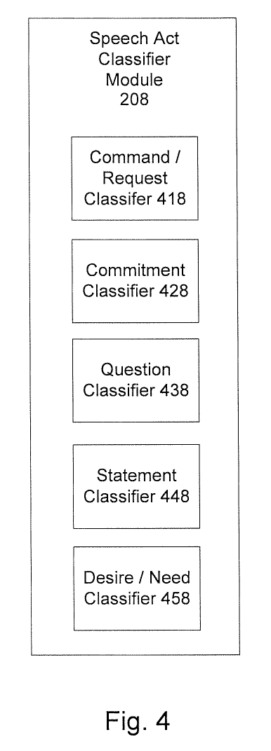

Referring to FIG. 3, a flow diagram showing exemplary modules within system 100 for email classification, information extraction, and email summarization, is shown, according to an exemplary embodiment. In FIG. 3, the same or corresponding elements as those of FIGS. 1-2 are referred to by the same or corresponding numerals. While shown as different elements, modules 202-218 may be considered to be part of the email mining platform 101, as explained above. Emails from a user's inbox may be retrieved by I/O module 250 and input into an email type classifier module 202.

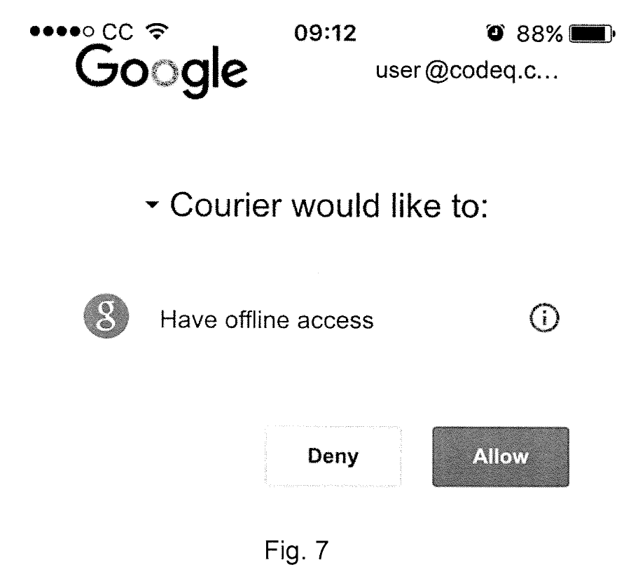

In an exemplary embodiment, the process of retrieving the user's email messages and providing such messages as input to the email mining platform 101 may be a server-side solution, not involving the user (client) at all. The I/O module 250 at (or within) the email mining platform 101 can automatically connect directly to external email providers (e.g., GMAIL, YAHOO, HOTMAIL) and retrieve email messages on behalf of the user. More specifically, with respect to GMAIL, for example, messages may be retrieved from GMAIL mailboxes using GMAIL's “RESTful API,” as would be appreciated by one of ordinary skill in the art. With reference to FIG. 7, an exemplary GUI asking the user for permission to access his/her emails offline is shown. In FIG. 7, “Courier” refers to the email mining platform 101. After permission is granted, and/or after the email messages are retrieved, the email messages may be stored in the email database 105 and made available to the various modules of the email mining platform 101 for processing.

Pulling email messages for a user and providing such messages as input to various modules of the email mining platform 101 may be done in two ways: full synchronization and partial synchronization. In full sync, when the user installs an email mining application (that implements the system disclosed herein) and authenticates with the email mining platform server for the first time, the I/O module 250 of the email mining platform connects to the user's email provider (e.g., GMAIL, YAHOO, HOTMAIL) and pulls the user's complete inbox and stores all messages in the email database 105. In partial sync, after the user installs an email mining application that implements the system disclosed herein and authenticates with the email mining platform server, the user's authentication information may be stored and the email mining server may periodically connect to the user's email provider and retrieve all new messages received since last sync event. Similar to full sync, such new email messages may be stored in email database 105. Partial synchronization may be implemented after full synchronization to retrieve new email messages, for example.

### Email Type Classifier Module 202

The email type classifier module 202 may classify an email as either botmail or conversational email, as described above and explained in further detail below. Email classified as conversational email may be input into the email zone identifier module 204 for further processing. Email classified as botmail may be input into the botmail summarizer module 218 for further processing. A particular email's classification may be stored in metadata associated with the particular email. Such email metadata may be stored in email database 105 and/or may be passed with the email to the various modules of the email mining platform 101.

Emails are classified as conversational or botmail using a machine learning model trained using sample data that was manually annotated into conversational or botmail categories. The exemplary machine learning model uses a particular algorithm called support vector machines. Each email is represented in the form of a vector with features that describe its content and metadata. Content features of the email are determined by the binary presence of each token (word) that the email contains after removing all punctuation. The metadata features of the email are determined through various binary features, including binary features that specify if the sender email address domain is in a curated list of known botmail domains, if the email sender name is in a curated list of known botmail names (i.e., no-reply, donotreply, webmaster, customer service, etc.), and/or if the email sender name is in the user contacts list. The machine learning model takes each vector with these features determined as explained above, analyzes them and outputs its prediction: viz., conversational or botmail.

### Email Zone Identifier Module 204

Email zone identification is carried out by the email zone identifier module 204 and entails finding and classifying the different structural zones in which email may be organized. Such “zones” include, for example, the salutation, signature, email body, reply text, earlier email, and one or more header zones. The header zone(s) may include a subject, From:, To:, Cc:, date, and any attachments, for example. Email zone identification is accomplished by matching email structural conventions with regular expressions. A regular expression is a sequence of characters that define a search pattern, mainly for use in pattern matching with strings, or string matching, such as “find and replace”-type operations. In practice what this means is that manually-defined patterns are matched against the content of each particular email. For example, a pattern for the salutation zone of an email could be, for example, “Hello,” “Hi,” “Hey,” “Good morning,” adjacent to the name of the email sender. In exemplary embodiments, the email zone identifier module 204 does not use machine learning, but rather uses pure rule-based patterns that are matched in order to find the different zones that make up the email.

Most emails have at least one header zone that includes a Subject line, a From: line, a To: line, and a Date: (or Sent:) line, and many emails have a Cc: line, or a Bcc: line. Earlier emails in an earlier email zone may also include a header zone. The From: line includes the sender's email address and/or name; the To: line includes one or more recipients' email addresses and/or names; the Date: or Sent: line typically includes the date and time of when the email was sent, and the Cc: and Bcc: lines include the email addresses and/or names of parties who were “carbon copied” or “blind carbon copied.” Other information in the header zone of an email may include a reply-to address, a subject of the email, or a message identification. The reply-to address may include an email address and/or name that is different from or the same as an email address and/or name in the From: line. The subject may include a subject of the email, and/or one or more FW: or RE: designations if an earlier email was forwarded or is a reply, for example. The message identification portion of an email header zone may include an indication of the importance or urgency of the email, for example. Elements in the header zone may be easily identified because they typically contain invariable words or strings, such as To:, From:, Subject, and Sent:, for example. The data within the header zone(s) may be used to identify who the email is from, who the email was sent to, the time/date the email was sent, the subject of the email, or the importance of the email, for example. Such data may be stored in email database 105 and/or may be passed with the email to the various modules of the email mining platform 101 in the form of metadata associated with the email.

A salutation field or zone may be found in many emails, and typically includes the recipient's name, or a greeting, such as “Dear,” “Hello,” “Hey,” “Hi,” “Mr.,” “Mrs.,” “Ms,” or “Dr.,” for example. The recipient's name may correspond to a name in the To: line in the header portion of the email. A list of common salutations may be stored in a portion of email database 105 and may be accessed when identifying zones of an email, such as a salutation zone. The form of salutation and/or names included in the salutation may be added to the email's metadata and stored in email database 105 and/or may be passed with the email to the various modules of the email mining platform 101.

The signature zone often contains a closing phrase, the name of the sender of the email, their title, email address, phone number, fax number, mailing address, an entity name, an entity address, and occasionally a confidentiality or tax statement, for example. The closing phrase may include “Best regards,” “Sincerely,” “Love,” “Regards,” “Thank you,” “Thanks,” etc. A list of common closing phrases may be stored in a portion of email database 105 and may be accessed when identifying zones of an email, such as a signature zone. The form of signature and/or name(s) included in the signature may be added to the email's metadata and stored in email database 105 and/or may be passed with the email to the various modules of the email mining platform 101.

The email body zone contains the message of the email and is typically separated from the header zone by a line break. The email body contains the substance of the message communicated from a first party (e.g., the sender) to a second party (e.g., the receiver). The text within the email body is identified and categorized to be part of the email body. Such text is later analyzed in detail for purposes of summarizing the email and/or extracting tasks from the email.

The email body may contain in-body quoted text, i.e., email text that is embedded within the email body and that quotes text from an earlier email. Each line of in-body quoted text may be prefaced by a “>” symbol, for example. Text that responds to or refers to in-body quoted text may be referred to as in-body quoting text, and may also be in the body of an email. Some email providers don't mark quoted material (reply text, for example) using the “>” symbol, but they do mark the beginning of earlier emails using an expression of the form “On May 15th 2015 name@domain.com wrote:”. Such markers may be used to identify email zones too. Further, html tags that indicate quoted material may be mined and the “>” symbol, for example, may be added by the email mining platform to mark this type of material independently of the email provider.

The earlier email zone may include a header zone and an email body zone of an email that was sent earlier in time to another email (i.e., a “parent” email). The earlier email zone is typically located below the email that was sent later in time. Each line of the earlier email zone is often preceded by a “>” symbol, or a similar symbol. The earlier email zone can be identified because it often has its own header zone, including the date when the earlier email was sent, the sender's name, the sender's email address, and often the word “wrote.” For example, an earlier email may be prefaced with the following computer-generated statement: “On Mon, Jul. 13, 2015 at 10:43 AM, Frank Bond <frank.bond123@bond.com> wrote:”. Additional earlier emails may contain a similar statement. The email zone identifier module 204 can identify such statements and classify the email text that follows such a statement accordingly. Such classifications may be stored as metadata associated with the “child” and/or “parent” email(s).

### Sentence Reconstructor and Analyzer Module 206

The sentence reconstructor and analyzer module 206 performs two main functions: (i) reconstructing sentences in the various email zones and (ii) analyzing reconstructed sentences by tokenizing, lemmatizing, tagging with parts of speech (PoS), and parsing the reconstructed sentences. When sending email in plaintext, the email sender's provider system splits sentences in emails in order to accommodate them to a particular user interface (UI). This creates a problem from a grammatical point of view because sentences are not split using grammatical marks (such as periods, exclamation marks, question marks, semi-colons, or commas, for example). Rather, the plaintext sentences are split at random points, thus leaving incomplete and ungrammatical sentences that need to be reconstructed.

Fortunately, many email clients send email in hypertext markup language (HTML) in addition to plaintext. Email content sent in wrapped HTML is not split in random places merely to suit a user interface. This means that content extracted from the HTML version of an email does not need to be reconstructed. Accordingly, system 100 gives priority to HTML content over plaintext content when available. In other words, for an email that arrives at I/O module 250, if such email has an HTML version associated therewith, the HTML version of the email will be used by the modules of the email mining platform 101.

Natural language processing analysis of reconstructed and/or extracted sentences differs depending on the email zone in which the sentences are located. On the one hand, text located within the email body zone or earlier email zone is tokenized, split into sentences, lemmatized and tagged for parts of speech. On the other hand, text embedded within inbody and inreply quoting text and reply text zones is tokenized and split in sentences. Lemmatizing and POS-tagging text in the inbody and inreply quoting text and reply text zones is a computationally expensive operation and unnecessary, and is therefore not performed in exemplary embodiments of the invention. Accordingly, the email zone classifications described above will be used to determine which text in the email is lemmatized, tagged for parts of speech, tokenized, and/or split in sentences.

Lemmatization refers to removing inflectional endings of words and returning the base or dictionary form of words, which are referred to as the “lemma.” Words may appear in several inflected forms. For example, the verb “to run” may appear as run, runs, ran, or running, and the lemma would be “run.” Accordingly, words that are lemmatized are reduced to their corresponding lemma before being passed to the next module.

PoS-tagging refers to marking words in a text (or corpus) with their corresponding part of speech, based on the word's definition and its context within the corpus. Common parts of speech include noun, verb, adjective, article, adverb, pronoun, preposition, conjunction, interjection. PoS-tagging is performed by VOLSUNGA using an algorithm called Hidden Markov Models. The tags for words that are PoS-tagged may be stored in the email's metadata and, accordingly, passed with the email to the various modules of the email mining platform 101. The PoS-tags may be sufficient to identify the word's part of speech. For example, tags for the parts of speech noun, verb, adjective, article, adverb, pronoun, preposition, conjunction, and interjection, for example, may be NN, VB, JJ, DT, RB, PRP, IN, CC, UH, respectively. By way of example, the sentence, “He drank the milkshake quickly.” would be first tokenized to “He drank the milkshake quickly.” and then lemmatization would return [‘he’, ‘drink’, ‘the’, ‘milkshake’, ‘quickly’, ‘.’] and PoS-tagged as [‘PRP’, ‘VBD’, ‘DT’, ‘NN’, ‘RB’, ‘.’], for example. In short, tokenization separates words and punctuation marks into distinct tokens. In the example above, tokenization simply separated the period and the last word of the sentence with a space. Another example where tokenization would do something somewhat more complex is the sentence: “I'm in San Diego.” The tokenized version would be “I'm in San Diego.” with spaces before the apostrophe and period. The lemmatized version of this sentence would be: “I be in San Diego.” with a space before the period.

Lemmatization and PoS-tagging may be implemented using VOLSUNGA, Dependency Parsing using Bllip. Dependency parsing is the process of analyzing the syntactic structure of sentences to determine which words depend on each other, syntactically speaking. For example, “I” in “I ate apples” depends on “ate” with its dependency label being ‘subject,’ and “apples” also depends on “ate” with its dependency label being ‘direct object.’ Bllip is a Python implementation of the Charniak parser, which is a statistical parser that uses context free grammars and word statistics to analyze all possible dependency analysis of sentences and select the one with the highest probability.

### Speech Act Classifier Module 208

Referring to FIG. 3, a speech act classifier module 208 is shown. Sentences may be summarized pragmatically by assessing the intentions behind the sentences and also the impact (expected or actual) of the sentences. This is accomplished by applying a refined and simplified list of speech acts to sentences in emails to exploit this information in order to produce emails summaries that are relevant from a pragmatic point of view. The refined list of speech acts may include, for example: (1) command/request, (2) commitment, (3) question, (4) statement, (5) desire/need, and (6) other. Each of these classifiers in the speech act classifier module 208 are discussed in further detail below.

Using this refined list of speech acts, an exemplary corpora comprising a collection of 492 emails were manually labeled. The sentences within each email were labeled as one of a command/request, commitment, desire/need, question, statement, or other.

Support vector machines (SVMs) were used in the classification task. Support vector machines are supervised learning models with associated learning algorithms that analyze data and recognize patterns, and are used for classification and regression analysis. Classifying individual sentences into one of the six speech acts identified above is best accomplished in a binary fashion. This multiclass classification task was cast into several binary classification tasks. Experiments showed that a linear kernel gives the best performance on the several binary classification tasks. For the experiments, we used the linear SVM classifier as implemented in scikitlearn (http://scikit-learn.org).

Each of the five binary speech act classifiers exploits a linguistically-motivated feature set, as is described below. Words in the email may be compared to a manually-complied list of words that are stored in a database or in a plaintext file and loaded each time the application/program is run.

### Command/Request Classifier (COMREQ) 418:

The feature set of the Command/Request (COMREQ) classifier 418 may be composed of four main binary features, named and indicating as follows:

beginsWithPoliteness:

A binary feature indicating whether or not a sentence starts with a politeness device such as “please.”

hasRequest:

A binary feature indicating whether or not a sentence has a request device such as “could you” or an action verb such as “update,” “change,” and “send.” hasRequest & hasSecondPronoun !& hasQuestionMark !& hasExclamationMark:

A binary feature indicating whether a sentence has a request device (e.g., “would you,” “could you,” “can you,” “let me know,” “let me”) and/or an action verb (e.g., “want,” “need,” “call,” “write,” “email”), but not a question mark nor an exclamation mark. The “!&” indicates “AND NOT.”

hasPoliteness:

A binary feature indicating whether or not a sentence includes a politeness device such as “please,” “could,” and “appreciate,” after the sentence's initial word. A sentence that begins with a politeness device is identified by the beginsWithPoliteness binary feature.

### Commitment Classifier 428:

The Commitment classifier 428 feature set may be composed of one feature, as follows:

hasCommitPhrase:

A binary feature indicating whether or not a sentence includes action devices such as, for example, “I will”, “I may”, “I can”, or “I will not”, for example. Such action devices indicate commitment to do, or refrain from doing, something.

### Desire/Need Classifier (DESNEED) 458:

The Desire/Need (DESNEED) classifier 458 feature set may be composed of one feature, as follows:

hasDesireVerb:

A binary feature indicating whether or not a sentence includes desire/need devices such as, for example, “want,” “hope,” “need,” and “hungry for.”

### Question Classifier 438:

The Question classifier 438 feature set may be composed of three features, as follows:

hasNonWhQuestionWord:

A binary feature indicating whether or not a sentence includes a non-Wh-question

word such as “can”, “could”, “will”, “would”, and “should,” for example.

hasWhQuestionWord:

A binary feature indicating whether or not a sentence includes a Whquestion

word such as “how,” “what,” “when,” “who,” and “why.”

hasQuestionMark:

A binary feature indicating whether or not a sentence includes a question mark.

### Statement Classifier 448:

The statement classifier 448 may exploit a total of nine different features, as follows:

hasThanking:

A binary feature indicating whether or not a sentence includes a thanking device such as “thanks,” “thank you,” and “grateful,” for example.

hasEmoticon:

A binary feature indicating whether or not a sentence includes an emoticon such as “;)”, “:)”, “:(”, “\hat{0}\hat{0}”, “:-)”, for example.

hasDashAndShort:

A binary feature indicating whether or not a sentence includes a dash and is shorter than four characters. Types of dashes include the em dash, en dash, and hyphen.

isSignatureLine:

A binary feature indicating whether or not a sentence includes signature line devices such as “(office),” “(cell),” “(personal),” “(work),” or “sent from my,” for example.

isAlphanumShort:

A binary feature indicating whether or not a sentence includes alphanumeric words and less than three words.

hasSignoff:

A binary feature indicating whether or not a sentence includes signing off devices such as “best,” “cordially,” “cheers,” “regards,” “sincerely,” and “yours,” for example.

hasNoFinalFullstop:

A binary feature indicating whether or not a sentence has a final full stop.

hasNamedEntity:

A binary feature indicating whether or not a sentence is one or two words and starts with a Capital letter and a comma “,” or an exclamation mark “!” (e.g., “Hey Paulo,”).

isOneWordSent:

A binary feature indicating whether or not a sentence is a length of one word.

### Questions Classifier Module 210

The questions classifier module 210 works in conjunction with the speech act classifier module 208 by further categorizing speech acts identified as questions (e.g., information requests) into particular types of questions. The questions classifier module 210 has two main purposes: (1) identify questions in emails that need to be answered by a user when responding to email conversations; and (2) provide fine-grained information about the nature of sentences to the conversational email summarizer in order to allow for more advanced post-processing rules that select relevant sentences to be included in email summaries.

The questions classifier module 210 was trained using information requests from a modification of two exemplary collections of texts, or corpora: ICSI-MRDA (Shriberg, Dhillon, Bhagat, Ang, & Carvey, 2004) and Switchboard SWBD-DAMSL (Jurafsky, Shriberg & Biasca, 1997). The ICSI-MRDA Corpus comprises hand-annotated dialog act, adjacency pair, and hotspot labels for seventy-five meetings identified in the ICSI meeting corpus (i.e., a corpus of how people interact in meetings). The Switchboard corpus is composed of approximately 2,400 telephone conversations between unacquainted adults.

A tagset used by these two corpora is shared and it is discussed in detail below. Since both corpora are transcriptions of spoken conversations, the sentences contained in both corpora lack the grammatical consistency and polish of written conversations. In order to adapt the extracted information requests to a written conversation setup like email conversations, the corpora were manually cleaned in order to remove repetitions, vacillations and other artifacts which are typical of spoken conversations and that their transcriptions reflect.

The tagset will now be discussed. The questions classifier module 210 may inherit its tagset from the SWBD-DAMSL, which is also shared by the ICSI-MRDA corpus. The definition of the classes defined by this set of tags can be found in the web document “Switchboard SWBD-DAMSL Shallow-Discourse-Function Annotation Coders Manual, Draft 13” (Jurafsky, Shriberg & Biasca, 1997), incorporated herein by reference in its entirety.

The original SWBD-DAMSL tagset has the following set of tags: qy, qw, qo, qr, qrr, d, g and qh (described below). Except “d” and “g” classes (declarative and tag questions, respectively), all other classes are mutually exclusive. This means that a question labeled, for example, as “qy” can also be labeled “d” and/or “g”, but cannot be labeled as “qo”, “qw” or “qr” at the same time. Drawing from this original set of tags and respecting the mutual exclusivity of the original question types, the inventors reviewed, restructured and adapted the annotations of both ICSI-MRDA and SWBD-DAMSL to contain the following set of annotations, which the questions classifier module 210 assigns to the different types of questions identified below.

(1) Yes/No questions are labeled “qy” by the questions classifier module 210. “qy” is used for yes-no questions only if they both have the pragmatic force of a yes-no question and if they have the syntactic and prosodic markings of a yes-no question (i.e., subject-inversion, question intonation).

(2) Wh-interrogative questions are labeled “qw” by the questions classifier module 210. These must have subject-inversion. “Echo-questions” with wh-in-place are considered “declarative questions” (marked with d, see below).

(3) Open-ended questions are labeled “qo” by the questions classifier module 210. An example open-ended question may ask “how about you?” “qo” is meant to address the kind of questions which place few if any syntactic constraints on the form of the answer.

(4) Or- questions are labeled “qr” by the questions classifier module 210. Or- questions are questions that offer two or more choices as answers to the listener or reader. The inventors restructured the SWBD-DAMSL and ICSI-MRDA tagset so that qrr questions, which are “or-clause tacked on after a y/n question”, are considered or- questions, too.

(5) Declarative questions are labeled “d” by the questions classifier module 210. Declarative questions are utterances which function pragmatically as questions but which do not have “question form” and/or subject-verb inversion.

(6) Tag questions are labeled “g” by the questions classifier module 210. A ‘tag’ question comprises a statement and a ‘tag’ which seeks confirmation of the statement. Because the tag gives the statement the force of a question, the tag question is coded ‘qŷg’. The tag may also be transcribed as a separate slash unit, in which case it is coded ‘̂g’. An example of a tag question is “You don't like broccoli, do you?”

(7) Rhetorical questions are labeled “qh” by the questions classifier module 210. The original category of information request defined for the SWBD-DAMSL corpus did not consider rhetorical questions as true questions as this type of question does not fall within the definition of “utterances that are jointly pragmatically, semantically, and syntactically questions.”

Rhetorical questions present a challenge for a classifier purely based on lexical and morphological features, given that they are examples of utterances whose form does not match their function. They have the structure of a question but the force of an assertion and so are generally defined as questions that neither seek information nor elicit an answer. See, e.g., Borkin 1971, Sadock 1971, Banuazizi 1999. This makes them unique within semantic and pragmatic analyses since “most utterances are assumed to be informative or at least information-seeking.” See, Rohde, 2006. 134. Even though rhetorical questions are not pragmatically and semantically questions, they are syntactically expressed as questions and not attempting to classify them would lead the classifier to inaccurately assign one of the other supported question classes. Therefore, an exemplary embodiment of the invention classifies this type of questions in order to set them apart from the set of true information requests and to yield more accurate results.

(8) Task questions are labeled “qt” by the questions classifier module 210. Task questions represent a new category that is not present in the SWBD-DAMSL tagset. This category includes questions originally classified as rhetorical questions, because they lack the intention of seeking information but they encapsulate an action request. For example, “Why don't you go ahead and call him today?” This new category allows the system to distinguish questions traditionally considered as rhetorical, such as “Who cares?” or “Who knows?”, from questions that intend to compel the listener or reader to take an action.

A support vector machine (SVM) classifier is a machine learning classifier used to learn the distinction among the eight different types of questions. An SVM classifier trained using the data and process described above may be considered to be the questions classifier module 210. To identify the eight different types of questions listed above (where some classes of questions are mutually exclusive) the inventors adopted a two-phase training and fine tuning approach: (1) a chained binary classifier approach, and (2) a probability-based approach that prevents questions from being assigned a mutually-exclusive question type label.

### (1) Chained Binary Classifiers:

For the first phase of training, eight different RBF kernel Support Vector Machine (SVM) binary classifiers were trained by creating eight different splits from the clean set of questions extracted from the above-mentioned corpora. A kernel in the context of the Support Vector Machines algorithm is the mathematical function used to map vectors to an n-dimensional space in order to fit the line that tells the algorithm how to classify new instances. The technique used here comprised learning a different classifier for each type of question. In order to do that we took all the manually labeled instances for a particular question type and generated a data split that has those instances and a set of randomly selected instances for all the other question types. So the distinction that the classifier learns is “is it this type of question or is it something different.” For example, if one wants to learn the classifier for “yes/no” questions, first one selects all “yes/no questions” and a subset of all the other types of questions and uses this data as the training data for the algorithm. What the algorithm will learn is “is this a yes/no question (i.e., class 1) or is it something different (i.e., class 0).” Each split contains sentences that belong to the category being identified (class 1) and sentences labeled as a different question type (class 0). Splits were designed to be balanced in terms of the number of sentences assigned to class 1 and sentences assigned to class 2. Thus, if class 1 was misrepresented with respect to class 0, class 0's size is shrunk to match class 1's size, and vice versa.

Unigrams and bigrams refer to a sequence of one or two elements in a string of words, letters, or syllables. A unigram is a single token (i.e., a word, a letter or a syllable, depending on the task at hand). In this case, unigram refers to a word. So in the sentence “who is your uncle?” there are five unigrams: “who”, “is”, “your”, “uncle”, “?”. Bigrams are a sequence of two unigrams. Using the same sentences, there are four bigrams: “who is”, “is your”, “your uncle”, “uncle ?”. Each individual binary classifier may use the set of features identified below. References to “position 0” or “position −1,” for example, refers to the token position in the sentences, where the tokens correspond to words or punctuation marks. Many programming languages, such as Python or Java, or zero-based, meaning an element at position 0 refers to the first position in the list or array, for example. Position −1 refers to the last position in the list, and position −2 refers to the second-to-last position in the list. In Python and Java, for example, positive indexing of lists means counting from left to right and negative indexing means counting from right to left.
Lemmas unigrams
Part-of-Speech tags unigrams
Part-of-Speech tags bigrams
Lemma present at position 0
Part-of-Speech tag present at position 0
Lemma present at position −1 if last lemma is not a punctuation mark or lemma present at position −2 if last lemma is a punctuation mark
Part-of-Speech tag present at position −1 if last lemma is not a punctuation mark or Part-of-Speech tag present at position −2 if last lemma is a punctuation mark
Position of the first token from the list of WH- pro-forms: ‘what’, ‘where’, ‘when’, ‘which’, ‘how’, ‘why’ and ‘who’.
Position of the first token labeled as ‘WRB’, ‘WP’, ‘WDT’ or ‘WP$’.
Position of the first token labeled as modal, ‘MD’
Position of the first token labeled as verb that is non-modal
Binary feature sentence contains conjunction ‘or’
If binary classifier is ‘qh’, binary feature “has sentence been assigned one of the following labels: qy, qo, qw, g or qt”
If binary classifier is ‘qo’, binary feature “has sentence been assigned one of the following labels: qy or qw”
If binary classifier is ‘qw’, binary feature “has sentence been assigned qy label”
Binary feature sentence contains rhetorical why+negation phrase (e.g., why not, why don't, why won't, why couldn't, etc.)
Binary feature sentence contains bigram “who knows”
Binary feature sentence contains bigram “what about”
Binary feature sentence contains bigram “how about”
Binary feature sentence contains bigram “who isn't”
Binary feature sentence contains bigram “what if”
Binary feature sentence contains bigram “what else”
Binary feature sentence contains bigram “can you”
Binary feature sentence contains bigram “could you”

Scaling, feature selection and dimensionality reduction is applied to the set of vectors collected for every binary classifier. In order to find the best values of hyperparameters C and gamma, grid search is consistently applied to all SVM classifiers.

### (2) Probability-Based Fine-Tuning and Mutually Exclusive Class Selection:

In order to boost the performance of the chained binary classifiers and, most importantly, ensure that no mutually exclusive classes are assigned to the same question, a second training phase was conducted by fine tuning question classification using the class assignment probabilities calculated by each individual binary classifier.

A class assignment probability threshold for each class was found by using a development corpus, thereby maximizing the global precision, recall and F1-score. In an exemplary embodiment, the most likely mutually exclusive class is assigned to each question.

### Conversational Email Summarizer Module 212

The conversational email summarizer module 212 may comprise a ranking linear regressor module 212a and a post-processing rules module 212b. The conversational email summarizer module 212 may use a two-staged hybrid strategy. First, sentences contained in emails are ranked by the ranking linear regressor module 212a so that sentences deemed to be the most important are designated for inclusion in summaries at the top of the ranking. Second, a set of discourse coherence-based post-processing rules are applied by the post-processing rules module 212b to ensure that the coherence of the generated summaries is not broken. By “coherence” is meant the conceptual relationships that comprehenders (i.e., people) use to construct a coherent mental representation of what is said in the discourse. Linguistic markers are used to capture the relatedness of ideas and concepts at the level of sentence-to-sentence transitions. Examples of linguistic markers include, “Therefore,” “In addition,” However,” “In spite of,” for example.

With respect to stage 1, or email sentence ranking, in an exemplary embodiment a binary classification scheme is not used. In binary classification for sentence ranking, sentences are classified as “included” or “not included” in the ultimate summary of the document (e.g., email). The trouble with binary classification is that different annotators (e.g., linguists who reads each instance and assign a label using a predefined set of labels) label sentences as worthy of inclusion in the summary or not. Rather, exemplary embodiments use a threshold approach, relying on an average annotator score as the exemplary threshold. In one example, at least three different annotators manually label a corpus of emails, indicating whether each sentence is essential, optional, or irrelevant. Using this corpus of manually-labeled sentences a regression-based model is trained so that it can assign an importance score to each sentence embedded within the email body. The importance score can be used as a ranking measure to order candidate sentences to be included (or not) in the final summary. The final summary is then created by appending the top scoring sentences (in descending order) until a predetermined number of sentences, or a predetermined percentage of sentences, is reached for inclusion in the final summary. The maximum number of sentences that can be added to the final summary may be dynamically calculated by being based on the length of the original email. Thus, the longer the email, the longer the summary. A predetermined percentage of sentences from the original email may be used in the summary (e.g., approximately 30% of the original sentences may appear in the summary).

The following exemplary set of possible features may be used by the regression-based model in order to learn from the training corpus:

(A) DA type, frequency DA types 1-6 (DA (Discourse Act) is a synonym of Speech Act, as defined for the speech act classifier module 208. Freq DA type 1-6 is the frequency within a particular set of sentences of each of the speech acts that the speech act classifier module 208 is able to recognize);

(B) Number of overlapping words with quoted sentences, total frequency of overlapping words with quoted sentences, number of overlapping words with thread sentences, total frequency of overlapping words with thread sentences, number of overlapping words with subject, total frequency of overlapping words with subject;

(C) Cosine similarity of sentence to message tf-idf centroid (tf-idf centroid=average of all sentence tf-idfs in message) (tf-idf stands for term frequency-inverse document frequency, and is the name of an algorithm that weighs word counts (in this case across an email sentences) in order to make it easy for another machine learning algorithm to determine which features it needs to pay more attention to); cosine similarity of sentence to quoted sentences tf-idf centroid (tf-idf centroid=average of all sentence tf-idf s in quoted message); cosine similarity of sentence to thread messages tf-idf centroid (tf-idf centroid=average of all sentence tf-idf's in thread messages); cosine similarity of sentence to subject tf-idf;

(D) Absolute position of sentence in the message divided by number of sentences in message; number of sentences in message;

(E) Number of recipients;

(F) Sentence length divided by longest sentence length in message; sentence length divided by longest sentence length in thread;

(G) Number of content words; average of all content words tf-idfs in sentence; sum of all content words tf-idf's in sentence;

(H) Sentence polarity raw score (i.e., the sum of all positive and negative scores associated with polarity-bearing words; words considered to have negative polarity subtract a predefined value from the score, whereas positive words add a predefined value to the score); sentence polarity purity (i.e., a metric that tells the algorithm if a sentence has mixed polarity or not, that is, if there are only positive or negative words or if they're mixed; this is calculated dividing the polarity raw score by the absolute polarity raw score (absolute meaning that the negative sign from the negative words score is turned into a positive sign));

(I) Sum of scores of keywords in sentences divided by highest keyword score in sentence. Keywords are extracted from each particular email and counts for these keywords (i.e., how many times a keyword shows up in a document) are collected and referred to as “keyword scores.”

A determination whether a sentence has particular words, using the following exemplary programming functions: hasNeed (sentence has the word “need”); hasMust (sentence has the word “must”); hasWant (sentence has the word “want”); hasLike (sentence has the word “like”); hasWould (sentence has the word “would”); hasCould (sentence has the word “could”); hasMay (sentence has the word “may”); hasWill (sentence has the word “will”); hasCan (sentence has the word “can”); hasMight (sentence has the word “might”); hasWhWord (sentence has a wh- question word); hasJJ (sentence has an adjective); hasJJR (sentence has a comparative adjective); hasJJS (sentence has a superlative adjective); hasNN (sentence has a noun); hasNNS (sentence has a plural noun); hasNNP (sentence has a proper noun); hasNNPS (sentence has a plural proper noun); hasPRP (sentence has a personal pronoun); hasRB (sentence has an adverb); hasRBR (sentence has a comparative adverb); hasRBS (sentence has a superlative adverb); hasMD (sentence has a model word); hasVB (sentence has a verb); hasVBD (sentence has a past tense verb); hasVBG (sentence has a present participle verb); hasVBN (sentence has a past participle ver); hasVBP (sentence has a present non-third person verb); hasVBZ (sentence has a present third person verb); hasWDT (sentence has a wh- adverb); hasWP$ (sentence has a possessive wh- pronoun); hasWRB (sentence has a wh- adverb); hasAppreciate (sentence has the word “appreciate”); hasHope (sentence has the word “hope”); hasLet (sentence has the word “let”); hasKnow (sentence has the word “know”); hasFYl (sentence has the acronym “FYI”); hasASAP (sentence has the acronym “ASAP”); hasPS (sentence has the acronym “PS”); hasYou (sentence has the word “you”); hasl (sentence has the word “I”); hasWe (sentence has the word “we”); hasThank (sentence has the word “thank”); hasPlease (sentence has the word “please”); hasYes (sentence has the word “yes”); hasNo (sentence has the word “no”); hasQuestion (sentence ends with a question mark); hasExclamation (sentence ends with an exclamation point); hasColon (sentence ends with a colon); isList (sentence is a list item); hasPhone (sentence has a phone number); hasURL (sentence has a URL); hasTime (sentence has a time expression); hasPerson (sentence has the name of a person); hasOrganization (sentence has the name of an organization); hasLocation (sentence has the name of a place); hasMoney (sentence has a money expression); hasDate (sentence has a date expression); hasMisc (sentence has a miscellaneous proper noun that is not recognized as either a person, location, or organization); hasRecipientName (sentence has the name of the email recipient); hasSenderName (sentence has the name of the email sender).

These particular words were chosen after studying the sentences contained in a collection of personal emails in order to determine which sentences, which were most important according to the annotations made by three different annotators. There could be other words to which the system might pay attention to, but the words identified above are the ones that generally indicate the importance of an email sentence (along with many other factors that the ranking linear regressor uses for predicting the importance of new, unseen sentences). The values returned by these functions are not scores, but binary. If a sentence has for example “please,” the hasPlease function will return a 1, otherwise it will return 0. Positions of words does not necessarily matter, but the position of the particular sentence is given weight. Sentences that have higher scores according to the output of the ranking linear regressor 212a will be ranked higher, but they won't be necessarily presented at the top of the summary, as their position in the original email is also taken into account.

### Post-Processing Rules Module 212b

After the ranking linear regressor 212a ranks sentences for summarization, a set of post-processing rules may be applied by the post-processing rules module 212b in order to enhance the coherence of the summary that is automatically generated. This process applies heuristic rules to add sentences to, and/or exclude existing sentences from, the summary. In short, an extractive approach is used to generate email summaries, meaning that sentences are selected to be included in the summary or they are excluded.

By application of the post-processing rules, the importance-ranking score of the set of sentences output from the ranking linear regressor 212a may be modified based on the relevance of the rule that suggested to add a particular sentence, as well as on the total number of rules that proposed to add the particular sentence. As a result, a new summary is generated by taking a predetermined percentage of the top scoring sentences of this new (post-processed) set from the old (ranking linear regressor) set. Furthermore, the new summary is used to take a small percentage of sentences of the old set (e.g., one or two sentences) in order to generate a short summary, which is intended to be used as the preview message of the email. The following sections describe more details of the exemplary inclusion and exclusion rules.

### Post-Processing Inclusion/Exclusion Rules

One exemplary post-processing rule may be termed “anaphora.” This rule aims to identify sentences that contain an anaphoric pronoun in the first words of the sentence. For example, the sentence “He says that the results are listed in . . . ” contains the pronoun “he,” which makes reference to a noun that it is probably mentioned in a previous sentence. In order to resolve this reference and present a more coherent text, the “anaphora” rule appends the immediate previous sentence if it is not yet part of the summary. The pronouns to be checked include personal pronouns, such as he, she, it, they; object/possessive pronouns, such as mine, yours, his, him, her, hers, its, their, them; and demonstrative pronouns, such as that, this, those, these.

Another exemplary post-processing rule may be termed “discourse markers.” Similar to the anaphora rule, this rule appends previous sentences to those that start with discourse markers. The markers can be single words or multiword phrases, such as therefore, hence, then, additionally, besides, but, as such, for example, I mean, in addition, even more, etc.

Another exemplary post-processing rule relies on comparative adjectives. This rule is similar to both the anaphora and discourse markers rules. A comparative adjective is used to compare two things. For example, looking at apples you can compare their size, determining which is big and which is bigger. The comparative ending (suffix) for short, common adjectives is generally “-er.” For most longer adjectives, the comparative is made by adding the word “more” (for example, “more comfortable”). With the comparative post-processing rule, sentences are identified based on whether a comparative is mentioned. For example, given a sentence beginning with a comparative such as “A much larger list of about 30 users . . . ,” one would want to know what previous “list” is smaller/larger than the one mentioned. If a sentence with a comparative is found, the rule appends the previous sentence to the summary. If the comparative adjective is immediately followed by the word “than,” then the previous sentence may not be appended to the summary because inclusion of the word “than” implies that the comparative is already in the included sentence.

Another exemplary post-processing rule relies on questions. Rigorous attention is given to question sentences since they can be seen as relevant elements to be included in a summary. This post-processing rule uses as input the speech acts from the speech act classifier module 208. If a sentence is classified as a question, then it verifies the question types as proposed by the questions classifier module 210. If the question sentence is not already included in the summary, the process appends the question sentence to the summary if the type of the question is not rhetorical. In addition, the process avoids appending sentences classified with more than one question tag that include the type declarative. For example, if a question has more than one question label and among those question labels the ‘declarative question’ label is included, this sentence is not appended. A declarative question is a type of question that does not have the traditional question structure. An example of a declarative question is “you're leaving?”

Another exemplary post-processing rule may provide for inclusion of the first sentence of the email. The purpose of this rule is to identify the cases where the first sentence of an email is missing from the summary. To include these sentences, they should meet certain criteria, such as having a certain minimum word length, or to avoid common introductory phrases such as “Dear X”, “FYI”, “How are you?” etc.

Another exemplary post-processing rule may provide for inclusion of the closing sentence of the email. This rule is similar to the previous one: it searches for relevant sentences at the end of the email that meet a given length criterion, are not included in a stop word list (e.g., “thanks”), and are not surrounded by more than one line break (which often indicates the sentence is a farewell-type sentence). Stop words may be defined as words that have very little meaning, such as “and”, “the”, “a”, etc. Other words that may be included in the specific stop words list include “thanks,” “thank,” and “regards.”

Yet another exemplary post-processing rule may allow for exclusion of lists. The goal of this rule is to identify sentences that are part of a list, in order to remove them from the email summary. The rule searches for certain typical markers for lists, such as extensive tab characters and line breaks, as well as recurring colons and semicolons that tend to indicate that a sentence's primary purpose is to present data in the form of a list.

Yet another exemplary post-processing rule may allow for exclusion of sentence fragments. This rule uses the PartOfSpeech tags of the words, to exclude those sentences that do not contain a verb. The idea behind this rule is that fragments, i.e., sentences which lack a verb, tend to indicate details, such as lists (not caught by the list_exclusion rule) or other types of data (such as “John Smith, supervisor”) that are irrelevant for a summary.

Yet another exemplary post-processing rule may allow for exclusion of NNPs (i.e., the post-tag that stands for proper noun). Similar to the above exemplary post-processing rules, this rule uses the PartOfSpeech tags to exclude sentences that only contain a list of proper nouns. Such lists tend to give details that are irrelevant for a summary.

The post-processing rules explained above are exemplary and other post-processing rules may be applied to remove some sentences from the “old” set (i.e., the output from the ranking linear regressor) or add some sentences thereto. While sentences may be added, the overall impact of the post-processing rules is to reduce the number of sentences in the old set to generate a short summary, which can be used as a preview message of the email.

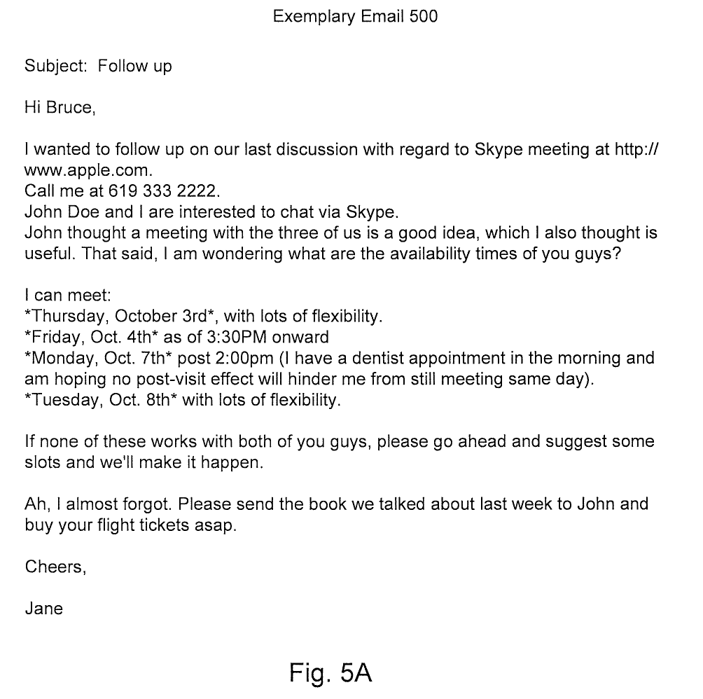

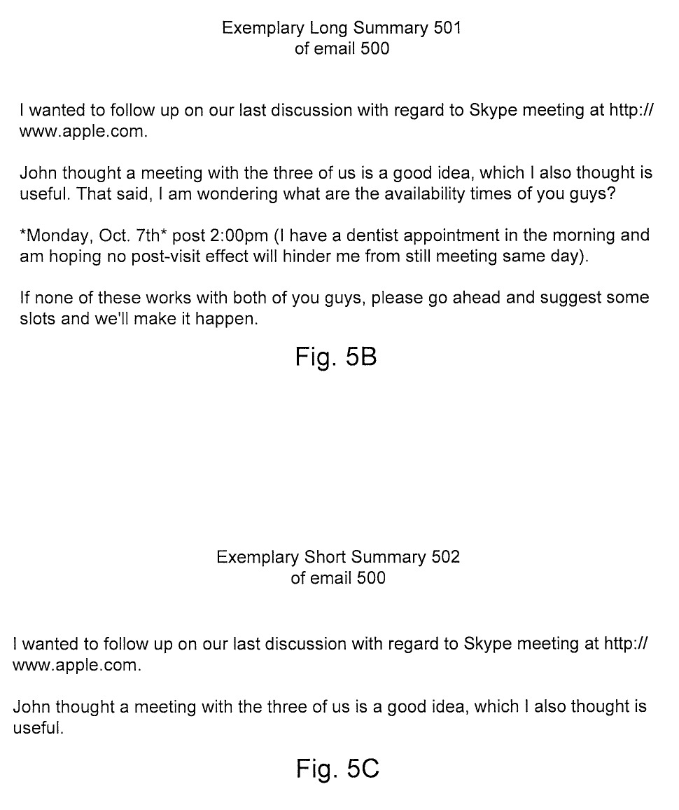

As explained above according to exemplary embodiments of the present invention, a linear regressor is used to rank sentences according to their importance, but more importantly, a discourse coherence layer is added in the form of post-processing rules to make sure that generated summaries are coherent. FIG. 5A shows an exemplary email 500 that has been summarized by the email mining platform 101 into an exemplary long summary 501 (FIG. 5B) and an exemplary short summary 502 (FIG. 5C). In an exemplary embodiment, both long and short summaries are produced. The length of the long summary is dynamic and depends on the length of the input email. This length (in number of sentences) is determined internally by the email mining platform 101 (e.g., the conversational email summarizer module 212) as described in this disclosure. Short summaries may be a maximum of 2 to 3 sentences long. Of course, if an email has only one sentence both the short and long summaries may have only one sentence.

### Tasks Extractor Module 214

In another exemplary embodiment of the invention, a tasks extractor module 214 may be implemented to provide a list of tasks identified in one or more emails. The task list can be included as part of the email summary explained above, or as a separate output.

The main goal of the tasks extractor module 214 is to extract sentences that explicitly indicate a task addressed to the receiver of the email. For this goal, the tasks extractor module 214 relies on the speech act tags previously identified by the speech act classifier module 208, as well as a syntactic analysis of the sentence (dependency parsing), and on the identification of verbs that are most likely to be the heads of task-denoting sentences. Once a sentence is identified as including a task, the next step is to extract the task's constituents.

For example, the process identifies the following sentence as a task and extracts its constituents: “Please send me the book before next Friday”—ACTION: send; RECIPIENT: me; OBJECT: the book; DATE: before next Friday.

The task extractor is called after parsing the email zones and classifying speech acts. Inputs to the task extractor module 214 include, for example, (i) the analyzed email zones, which are used to search for task sentences in the main content of the email, i.e., the body, body_quoting_text and reply_quoting_text zones; (ii) a list of task verbs and their main arguments, previously identified and scored during a manual training; and (iii) the syntactic dependency tree of the sentence. The syntactic dependency tree is a list of tuples with the form “head, dependent, relation name.” For example, the sentence “Please send me the book” has the following syntactic dependencies: “send, Please, discourse”; “ROOT, send, root”; “send, me, iobj” (indirect object); “book, the, det” (determiner); “send, book, dobj” (direct object).

With respect to the manual training identified above, it comprises several steps. The first step is to collect task-related verbs from the exemplary Enron corpus. The ENRON data set was preprocessed with POS-tagging and dependency parsing, and different methods were run to extract task-related verbs. Those methods include: (i) running the speech act classifier module 208 on the sentences of the corpus and extracting verbs from sentences classified as COMMAND/REQUEST or DESIRE/NEED, (ii) extracting likely imperatives by the criterion of position in the sentence and bare verb form, (iii) identifying common patterns on the dependency parse trees, such as whether a verb occurs with a subject “you,”, or whether a verb occurs with a recurrent verb auxiliary (e.g., “should”, “must”, “need”, “want” or “try”). Next, the sentences of the task-related verbs are manually analyzed to register the possible mappings between a verb dependency argument and its correspondent task element. For example, the verb ‘send’ has a common argument called ‘dobj’, which is usually assigned to the task element ‘OBJECT’. As result of this manual analysis, a task verb tuple is generated for each verb, the verb tuple containing: <task_verb, task_element, dependency_argument>, or by way of example <“send”, “OBJECT”, “dobj”>. Each tuple is then scored in order to represent the probability that a given task_element occurs parsed as the dependency_argument in question, given that specific task_verb. More specifically, the score may be calculated as follows: task_verb tuple=task_verb percentages*conditional probability of the task_verb, where the task_verb percentages=total task sentences, and where the task_verb contains the task_element/total sentences with the task verb; and conditional probability=occurrences of the task_element corresponding to the dependency_argument on all task sentences/occurrences of the task_element on the corpus.

With respect to syntactic dependencies, dependency parsing is the process of analyzing the syntactic structure of sentences to determine which words depend on which words, syntactically speaking. For example, in the sentence is “Please send me the book”, “me” depends on “send” and their relationship is iobj (that is, inderect object). In syntactic dependency theory all sentences have a dummy word (ROOT) that governs the entire sentence. The main verb of every sentence depends on ROOT and their dummy relationship is “root”. The syntactic dependency tree that works as input of the task extractor is a list of tuples with the form “head, dependent, relation name.” For example: [(send, Please, discourse), (ROOT, send, root), (send, me, iobj), (book, the, det), (send, book, dobj)] may represent a syntactic dependency tree.

The task extractor module 214 may comprise a number of sub-modules to carry out the task extraction functions and produce an extracted task list output. One such sub-module of the task extractor module 214 may be termed the task classifier sub-module, and may be considered to be part of the task extractor module 214. The task classifier submodule decides if a sentence containing any of the task verbs is good enough to be considered as a task candidate or not. If a verb from the task verb list is present, the task classifier sub-module evaluates if a sentence is a task or a non-task using the speech act tags assigned by the speech act classifier, as well as a set of syntactic rules (identified below) applied to the list of syntactic dependencies of the sentence. The speech act tags used to recognize a possible task include the command/request and desire/need tags.

The following set of exemplary syntactic rules #1-5 can be used to reinforce and validate a sentence as a task.

Syntactic rule #1: The task verb is a head, the relation is “nsubj” (nominal subject) and the dependent is “you”. For example, “Could you please send me the book”

Syntactic rule #2: The task verb is a head and the dependent is a modal verb, e.g., “should”, or “must”. For example, “You must send me the book.”

Syntactic rule #3: The task verb is a head, the relation is “xcomp” (open clausal complement) and the dependent is a relevant xcomp verb, e.g., “try”, “want”, “need”, or “require”. For example, “I need you to send me the book.”

Syntactic rule #4: The task verb is a head, the dependent is “Is” and the task verb exists as a dependent of another dependency where the head is the verb “let”. For example, “Let's send the book.”

Syntactic rule #5: The sentence is in imperative form, i.e., it starts with the task verb and the task verb is a dependent of a ROOT head. For example, “Send the book.”

The following set of exemplary syntactic rules #6-13 can be used to discard a sentence as a possible task.

Syntactic rule #6: The task verb is a head and it contains a relation “neg” (negation). For example, “Do not send me the book.” In syntactic dependency theory a word is a head of all of its dependents, that is all the words that depend on it. With respect to syntactic rule #6, the task verb is the head of a negation.

Syntactic rule #7: The task verb is a dependent, the relation is a clausal complement relation (xcomp or ccomp) and the head occurs in a dependency with a negation relation. For example, “You should not send me the book.”

Syntactic rule #8: The task verb is a head and the dependent is “not” or “no”. (Same as previous rule without considering the relation name, used for those cases where the dependency parser cannot recognize the relation).

Syntactic rule #9: Task verb is a head and the dependent is a question auxiliary verb that occurs in the first position of the sentence. For example, “Did you send me the book?”

Syntactic rule #10: The task verb is a head, the relation is “nsubj” and the dependent is a stop subject, e.g., “I”, “we”, “they”. For example, “They send you the book.”

Syntactic rule #11: The task verb is a head, the relation is “xcomp” and the dependent occurs in a dependency with a stop subject. For example, “They will send you the book.”

Syntactic rule #12: The task verb is a head, the relation is “xcomp”, the dependent occurs in a “acomp” dependency (adjectival complement) with a stop subject. For example, “I will be able to send you the book.”

Syntactic rule #13: The task verb is a head, the relation is “aux” (auxiliary) and the dependent is a stop auxiliary verb (e.g., “can”, “could”, “will”) that is after the subject of the task verb (which indicates that it is a rhetorical task-related sentence). For example, “With this tool you can send a message to your contacts.”

The output of the task classifier module 214 is the modified list of matched task verbs per sentence. If a non-task is detected, the corresponding task verb will be removed from the list.

A second sub-module of the task extractor module 214 may be termed the argument extractor module, and may be considered to be part of the task extractor module 214. This second submodule identifies the elements of the task. For each candidate sentence, the process extracts the task verb and maps its grammatical dependencies to their correspondent task arguments. This process uses the output of the dependency parser and a trained model containing a map of the grammatical relations of a verb and their possible task arguments.

For example, the dependency parser retrieves the following dependencies for the sentence “Please send the document to John”: send, please, discourse; ROOT, send, root; document, the, det (determinate); send, document, dobj (direct object); send, John, prep_to (preposition to).

The grammatical relations (dobj, prep_to, etc.) are mapped to their corresponding arguments, which in this case are: root=ACTION, dobj=OBJECT and prep_to =RECIPIENT. As a result, the process extracts the following elements of a task: ACTION: send; OBJECT: the book; RECIPIENT: to John.

Finally, the task arguments are scored in order to indicate a confidence in the correctness of the extracted elements. For example, in the case of the verb “send,” the mapping between the element “OBJECT” and the relation “dobj” has an exemplary score of 0.57, which means that there is a 57% chance that a given sentence with the task verb “send” has an OBJECT that is parsed as a “dobj” relation. In order to score the automatically-extracted task arguments for each sentence, we previously define a threshold to identify what are the essential elements of a verb (e.g., OBJECT, SUBJECT, etc.). The threshold may be set to 0.5, for example, and is applied to the task verb tuples generated on the manual training. In this way, the task elements of task verb tuples with a score above that threshold will be considered as essential. For example, the following task elements are considered essential for the verb “send”: OBJECT, RECIPIENT. Using this exemplary threshold, we calculate the score of the extracted task arguments for a given task verb as follows:

task arguments score=confidence average/task_element recall

where: confidence average=conditional probability of the essential elements/conditional probability of the automatically extracted essential elements, and

task_element recall=(automatically extracted essential elements/essential elements)/total essential elements of the verb

The following is a list of task verbs that were manually classified as being indicative of a task: affirm, answer, ask, attach, bcc, book, buy, communicate, confirm, corroborate, dial, dismiss, e-mail, email, explain, explore, forward, fwd, give, invite, lease, look, mail, move, order, organise, organize, outline, pay, post, prepare, purchase, re-email, re-schedule, re-send, rebook, reforward, remove, render, reply, research, resend, reserve, respond, resubmit, resume, review, rewrite, schedule, search, send, submit, summarise, summarize, supply, suspend, tell, transfer, transform, translate, and wire.

For computer specific task verbs, the manually-classified arguments include the following: ACTION (the task verb); OBJECT (mainly the direct object of the task verb); RECIPIENT (in the sense of thematic roles, e.g., iobj (indirect object) of the verb “to send” is the person or object that receives the action); DATE (any date expression stated on the task sentence); LOCATION (any possible location stated on the task sentence); IMPORTANCE (any expression denoting the importance of the task, such as ASAP); PURPOSE (any expression denoting the reason or rationale of a task, such as “in order to deal with this issue”); METHOD (any expression denoting the means by which a task is done, such as “with this form”); SOURCE (meaning varies with each verb, but SOURCE covers expressions denoting a location (sometimes abstract) from which the action occurs, such as the person from whom something is borrowed); CONTENT (any expression not covered by the above categories denoting the content of some informational object, often an email, such as in “email John with this information”); PAYER (any expression not covered by the above categories denoting an entity responsible for paying for something, such as the “to” argument of “charge”—“charge it to X”); PHONE/FAX (any expression not covered by the above denoting a phone or fax number, respectively); ADDRESSEE (a vocative expression denoting the intended agent of the task, usually followed by an imperative (or interrogative request), such as “Dave, please do this” or “Dave, could you do this?”).

A further step in the extraction of tasks is to keep the sentences that are tagged with one of the relevant speech act tags identified by the speech act classifier module 208, but that cannot be classified as tasks in the task extraction process. The relevant speech act tags are Command/Request and Desire/Need. If the sentence cannot be fully parsed when trying to find all the task components, but it has been labeled by the speech act classifier module 208 as one of those two types of speech acts, then it is treated as a “task by discourse.” The further step of extraction of tasks may be termed “task by discourse.” A true task sentence may not be able to be identified due to the following scenarios: (i) the sentence does not contain a verb from the task verb list, or (ii) the score of the automatically extracted task does not pass the confidence threshold assigned in the scoring of arguments. For this reason, such sentences are tagged with “task by discourse,” which aims to improve the coverage of the identification of sentences that denote a request to the addressee of the email. An example of a task by discourse would be: “If none of these works with both of you guys, please go ahead and suggest some slots and we'll make it happen.”

Tasks are just a subset of all the actionable items that can be identified in emails. Questions contained in emails can be thought of as actionable items, too, when emailed, as senders expect to receive an answer for such questions. This means that answering each of such questions is also a task that email users need to act upon. Since most questions are not processed for task extraction, actionable questions need to be identified independently from the task extractor. Questions may be classified as actionable items if: (i) their question type is: a wh-question, an open-ended question, a yes/no question, an or question or task question; (ii) the length of the sentence is larger than three tokens. An example of this would be a wh-question such as: “What do you think of this idea?”

With reference to the exemplary email 500 in FIG. 5, the following is an exemplary raw output of the tasks extractor that would be stored in email database 105, and further processed for display to the user. The “$$$” represents a token separator in the exemplary raw output.

The text in exemplary email 500 is analyzed for tasks as described above, and an exemplary raw output is as follows:

### Tasks by Discourse:

[‘TASK_DISCOURSE::I$$$wanted$$$to$$$follow$$$up$$$on$$$our$$$last$$$discussion$$$with$$$regard$$$to$$$Skype$$$meeting$$$at$$$http://www.apple.com.’]
[‘TASK_DISCOURSE::Call$$$me$$$at$$$619$$$303$$$7288.’]
[‘TASK_DISCOURSE::John$$$Doe$$$and$$$I$$$are$$$interested$$$to$$$chat$$$via$$$Skype.’]
[‘TASK_DISCOURSE::*Monday,$$$Oct.$$$7th*$$$post$$$2:00pm$$$(I$$$have$$$a$$$dentist$$$appointment$$$in$$$the$$$morning$$$and$$$am$$$hoping$$$no$$$post- visit$$$effect$$$will$$$hinder$$$me$$$from$$$still$$$meeting$$$same$$$day).’]
[“TASK_DISCOURSE:If$$$none$$$of$$$these$$$works$$$with$$$both$$$of$$$you$$$guys,$$$please$$$go$$$ahead$$$and$$$suggest$$$some$$$slots$$$and$$$we'll$$$make$$$it$$$happen.”]

The tasks by discourse identified above are parsed by identifying and extracting the statements that are most likely to be considered tasks, according to the rules described above. The exemplary tasks by discourse listed above would be parsed into the following:

### Fully Parsed Tasks:

[‘ACTION::send, IMPORTANCE::asap, RECIPIENT::to$$$John, OBJECT::the$$$book$$$we$$$talked$$$about$$$last$$$week’, ‘ACTION::buy, OBJECT::your$$$flight$$$tickets’]

The fully parsed tasks are further processed for output to the user in an easy-to-read format. The format may vary, but an exemplary task list output based on the above is as follows:
send the book we talked about last week to John
buy your flight tickets

Referring to FIG. 6, an illustrative flowchart of a method for summarizing emails and extracting tasks is shown. This exemplary method 600 is provided by way of example, as there are a variety of ways to carry out methods according to the present disclosure. The method 600 shown in FIG. 6 can be executed or otherwise performed by the various systems and modules described above. Each block shown in FIG. 6 represents one or more processes, decisions, methods or subroutines carried out in exemplary method 600, and these processes, decisions, methods or subroutines are not necessarily carried out in the specific order outlined in FIG. 6, nor are each of them required. Input and/or output are shown in italics in FIG. 6. Referring to FIG. 6, exemplary method 500 may begin at block 610.

At step 610, a raw email is input into an email parser and is parsed. The email parser may be, for example, the Python email parsing library. Parsed email subject and body get inputted to the NLP system. An exemplary raw email input may be as follows:
Delivered-To: john.doe@gmail.com
Received: by 10.194.151.6 with SMTP id um6csp100453wjb;
   Wed, 2 Oct. 2013 13:25:12-0700 (PDT)
Return-Path: <jane.doe@gmail.com>
Received-SPF: pass (google.com: domain of jane.doe@gmail.com designates 10.224.41.10 as permitted sender) client-ip=10.224.41.10
Authentication-Results: mr.google.com;
   spf=pass (google.com: domain of jane.doe@gmail.com designates 10.224.41.10 as permitted sender) smtp.mail=jane.doe@gmail.com;
   dkim=pass header.i=@gmail.com
X-Received: from mr.google.com ([10.224.41.10])
   by 10.224.41.10 with SMTP id m10mr6655232qae.16.1380745511958 (num_hops=1);
   Wed, 2 Oct. 2013 13:25:11-0700 (PDT)
DKIM-Signature: v=1; a=rsa-sha256; c=relaxed/relaxed;
   d=gmail.com; s=20120113;
   h=mime-version:date:message-id:subject:from:to:content-type;
   bh=btfGcFeoOGN6FdWC1rH0hPNIYagkrrflAoYvgsfbPM0=;
   b=MpAnDmiw+H4SCmZFFDeD2VLSeSXyWENQrovcY3vUndDqIqitm+FFGYPCS2fqOLMM8Fp
   VEcjii5NUlq117QQ0vyO5urMCGLpkOnUiwxMhRMGvL2mxFrmknAM6H94wgWi21sePero
   EfnfwRM3wLxrTd6xYg+rmIyTg2qAQcFwVdB1aVRrxVOPTdJkpKO4OhKiyv+zJQrYYveW
   06T43sFJdIX9SVivI+LV9hfa2BAtB7KPq+5RmNCUuic+DfGUwlz5TrHO6qG58vKefRdY
   QkJ6zq5dHhx5AGmHUDwd1MKSGj+qC8Gd2VVYwKMdiJpGG+xCLxnrcSWIt1ZJ0A70MhfO
   5cZQ==
MIME-Version: 1.0
X-Received: by 10.224.41.10 with SMTP id m10mr6078260qae.16.1380745511528;
Wed, 2 Oct. 2013 13:25:11-0700 (PDT)
Received: by 10.224.119.199 with HTTP; Wed, 2 Oct. 2013 13:25:11-0700 (PDT)
Date: Wed, 2 Oct. 2013 16:25:11-0400
Message-ID: <CA+aRK5cRicvuHGWMskmAM+pC−
HmTWx5oV3QCRMh7wqf7x=EANg@mail.gmail.com>
Subject: Follow up
From: =?UTF-
8?B?CU11aGFtbWFkIEFiZHVsLU1hZ2VlZCAo2YXYrdmF2K8g2LnYqNiv2KfZhNmF2KzZitivKQ==?=<jane.doe@gmail.com>
To: Bruce Smith <bruce@smith.io>, John Doe <john.doe@gmail.com>
Content-Type: multipart/alternative; boundary=047d7b6760debd713a04e7c7dd22--047d7b6760debd713a04e7c7dd22
Content-Type: text/plain; charset=UTF-8
Hi Bruce,
I wanted to follow up on our last discussion with regard to Skype meeting at
http://www.apple.com.
Call me at 619 333 2222.
John Doe and I are interested to chat via Skype.
John thought a meeting with the three
of us is a good idea, which I also thought is useful. That said, I am
wondering what are the availability times of you guys?
I can meet:
*Thursday, October 3rd*, with lots of flexibility.
*Friday, Oct. 4th* as of 3:30 PM onward
*Monday, Oct. 7th* post 2:00 pm (I have a dentist appointment in the morning and am hoping no post-visit effect will hinder me from still meeting same day).
*Tuesday, Oct. 8th* with lots of flexibility.
If none of these works with both of you guys, please go ahead and suggest some slots and we'll make it happen.
Ah, I almost forgot. Please send the book we talked about last week to John and buy your flight tickets asap.
Cheers,
Jane

An exemplary output from the email parser is shown in FIG. 5. At 620, after the email is parsed, the parsed email and body (FIG. 5) is input to the email type classifier module 202, which is responsible for determining whether the email is conversational email or botmail, as described above. Output from the email type classifier module may comprise a binary label of “0” for conversational email, or “1” for botmail.

At 630, emails classified as conversational email (e.g., “0” from 620) are input into the email zone identifier module 204, which parses the actual content of the email body into different zones: salutation, body, signature, reply text, etc. The output from step 630 may be a data structure (e.g., a Python data structure) called dictionary and key-value pairs that encapsulate each of the identified email zones, as follows:
{‘body’: “\nI wanted to follow up on our last discussion with regard to Skype meeting at http://www.apple.com.\nCall me at 619 303 7288.\nJohn Doe and I are interested to chat via Skype.\nJohn thought a meeting with the three of us is a good idea, which I also thought is useful. That said, I am wondering what are the availability times of you guys?\n\nI can meet:\n*Thursday, October 3rd*, with lots of flexibility.\n*Friday, Oct. 4th* as of 3:30 PM onward\n*Monday, Oct. 7th* post 2:00 pm (I have a dentist appointment in the morning and am hoping no post-visit effect will hinder me from still meeting same day).\n*Tuesday, Oct. 8th* with lots of flexibility.\n\nIf none of these works with both of you guys, please go ahead and suggest some slots and we'll make it happen.\n\nAh, I almost forgot. Please send the book we talked about last week to John and buy your flight tickets asap.\n”, ‘body_quoting_text’: None, ‘reply_quoting_text’: None, ‘reply_quoted_text’: None, ‘signature’: ‘\nCheers,\n\nJane’, ‘salutation’: ‘Hi Bruce,\n\n’, ‘reply_text’: None, ‘body_quoted_text’: None}

The actual body of the email, as parsed in step 630, along with the email subject, as parsed in step 610, then undergo two different processes. If the parsed email body comes from the plain text MIME part of the raw email, its sentences are reconstructed. If the parsed email body comes from the html MIME part of the raw email, sentence reconstruction is not performed as html is non-destructive from a sentence point of view. At step 640, the actual email body (i.e., without salutation, signature, reply text, etc.) and the email subject are analyzed at the sentence reconstructor and analyzer module 206, by going through the following steps: Tokenization, Sentence splitting, Part-of-Speech tagging, Syntactic dependency parsing, Named Entity extraction and classification. Each of these steps are explained in further detail above. The output of step 640 is a data structure (e.g., a Python data structure) called dictionary with key-value pairs that encapsulates the processed sentences as described above. An exemplary output from step 640 is as follows:
defaultdict(<type ‘list’>, {‘body’: defaultdict(<type ‘list’>, {‘non_{—} filtered_tokLemSentences’: [[‘i’, ‘want’, ‘to’, ‘follow’, ‘up’, ‘on’, ‘our’, ‘last’, ‘discussion’, ‘with’, ‘regard’, ‘to’, ‘Skype’, ‘meeting’, ‘at’, ‘http://www.apple.com’, ‘.’], [‘call’, ‘me’, ‘at’, ‘619 303 7288’, ‘.’], [‘john’, ‘Doe’, ‘and’, ‘i’, ‘be’, ‘interested’, ‘to’, ‘chat’, ‘via’, ‘Skype’, ‘.’], [‘john’ ‘think’, ‘a’, ‘meeting’, ‘with’, ‘the’, ‘three’, ‘of’, ‘us’, ‘be’, ‘a’, ‘good’, ‘idea’, ‘,’, ‘which’, ‘i’, ‘also’, ‘thought’, ‘be’, ‘useful’, ‘.’], [‘that’, ‘say’, ‘,’, ‘i’, ‘be’, ‘wonder’, ‘what’, ‘be’, ‘the’, ‘availability’, ‘time’, ‘of’, ‘you’, ‘guy’, ‘?’], [‘i’, ‘can’, ‘meet’, ‘:’], [‘*Thursday’, ‘,’, ‘october’, ‘3rd*’, ‘,’, ‘with’, ‘lot’, ‘of’, ‘flexibility’, ‘.’], [‘*Friday’, ‘,’, ‘Oct.’, ‘4th*’, ‘as’, ‘of’, ‘3:30 PM’, ‘onward’], [‘*Monday’, ‘,’, ‘Oct.’, ‘7th*’, ‘post’, ‘2:00 pm’, ‘(’, ‘i’, ‘have’, ‘a’, ‘dentist’, ‘appointment’, ‘in’, ‘the’, ‘morning’, ‘and’, ‘be’, ‘hop’, ‘no’, ‘post-visit’, ‘effect’, ‘will’, ‘hinder’, ‘me’, ‘from’, ‘still’, ‘meeting’, ‘same’, ‘day’, ‘)’, ‘.’], [‘*Tuesday’, ‘,’, ‘Oct.’, ‘8th*’, ‘with’, ‘lot’, ‘of’, ‘flexibility’, ‘.’], [‘if’, ‘none’, ‘of’, ‘these’, ‘work’, ‘with’, ‘both’, ‘of’, ‘you’, ‘guy’, ‘,’, ‘please’, ‘go’, ‘ahead’, ‘and’, ‘suggest’, ‘some’, ‘slot’, ‘and’, ‘we’, “11”, ‘make’, ‘it’, ‘happen’, ‘.’], [‘ah’, ‘,’, ‘i’, ‘almost’, ‘forget’, ‘.’], [‘please’, ‘send’, ‘the’, ‘book’, ‘we’, ‘talk’, ‘about’, ‘last’, ‘week’, ‘to’, ‘john’, ‘and’, ‘buy’, ‘your’, ‘flight’, ‘ticket’, ‘asap’, ‘.’]], ‘filtered tokLemSentences’: [[ ], [ ], [ ], [ ], [ ], [ ], [ ], [ ], [ ], [ ], [ ], [ ], [ ]], ‘non_filtered_posSenteces’: [[‘PRP’, ‘VBD’, ‘TO’, ‘VB’, ‘RB’, ‘IN’, ‘PRP$’, ‘JJ’, ‘NN’, ‘IN’, ‘NN’, ‘TO’, ‘NNP’, ‘NN’, ‘IN’, ‘NN’, ‘.’], [‘NNP’, ‘PRP’, ‘IN’, ‘NN’, ‘.’], [‘NNP’, ‘NNP’, ‘CC’, ‘PRP’, ‘VBP’, ‘JJ’, ‘TO’, ‘VB’, ‘IN’, ‘NNP’, ‘.’], [‘NNP’, ‘VBD’, ‘DT’, ‘NN’, ‘IN’, ‘DT’, ‘CD’, ‘IN’, ‘PRP’, ‘VBZ’, ‘DT’, ‘JJ’, ‘NN’, ‘,’, ‘WDT’, ‘PRP’, ‘RB’, ‘NN’, ‘VBZ’, ‘JJ’, ‘.’], [‘DT’, ‘VBD’, ‘,’, ‘PRP’, ‘VBP’, ‘VBG’, ‘WP’, ‘VBP’, ‘DT’, ‘NN’, ‘NNS’, ‘IN’, ‘PRP’, ‘NNS’, ‘.’], [‘PRP’, ‘MD’, ‘VB’, ‘:’], [‘NNP’, ‘,’, ‘NNP’, ‘NN’, ‘,’, ‘IN’, ‘NNS’, ‘IN’, ‘NN’, ‘.’], [‘NNP’, ‘,’, ‘NN’, ‘NN’, ‘IN’, ‘IN’, ‘NN’, ‘NN’], [‘NNP’, ‘,’, ‘NN’, ‘NN’, ‘NN’, ‘NN’, ‘(’, ‘PRP’, ‘VBP’, ‘DT’, ‘NN’, ‘NN’, ‘IN’, ‘DT’, ‘NN’, ‘CC’, ‘VBP’, ‘VBG’, ‘DT’, ‘NN’, ‘NN’, ‘MD’, ‘VB’, ‘PRP’, ‘IN’, ‘RB’, ‘NN’, ‘JJ’, ‘NN’, ‘)’, ‘.’], [‘NNP’, ‘,’, ‘NN’, ‘NN’, ‘IN’, ‘NNS’, ‘IN’, ‘NN’, ‘.’], [‘IN’, ‘NN’, ‘IN’, ‘DT’, ‘NNS’, ‘IN’, ‘DT’, ‘IN’, ‘PRP’, ‘NNS’, ‘,’, ‘VB’, ‘VB’, ‘RB’, ‘CC’, ‘VB’, ‘DT’, ‘NNS’, ‘CC’, ‘PRP’, ‘MD’, ‘VB’, ‘PRP’, ‘VBP’, ‘.’], [‘UH’, ‘,’, ‘PRP’, ‘RB’, ‘VBN’, ‘.’], [VB′, ‘VB’, ‘DT’, ‘NN’, ‘PRP’, ‘VBD’, ‘IN’, ‘JJ’, ‘NN’, ‘TO’, ‘NNP’, ‘CC’, ‘VB’, ‘PRP$’, ‘NN’, ‘NNS’, ‘NN’, ‘.’]], ‘tok_sentences’: [[‘I’, ‘wanted’, ‘to’, ‘follow’, ‘up’, ‘on’, ‘our’, ‘last’, ‘discussion’, ‘with’, ‘regard’, ‘to’, ‘Skype’, ‘meeting’, ‘at’, ‘http://www.apple.com’, ‘.’], [‘Call’, ‘me’, ‘at’, ‘619_303_7288’, ‘.’], [‘John’, ‘Doe’, ‘and’, ‘I’, ‘are’, ‘interested’, ‘to’, ‘chat’, ‘via’, ‘Skype’, ‘.’], [‘John’, ‘thought’, ‘a’, ‘meeting’, ‘with’, ‘the’, ‘three’, ‘of’, ‘us’, ‘is’, ‘a’, ‘good’, ‘idea’, ‘,’, ‘which’, ‘I’, ‘also’, ‘thought’, ‘is’, ‘useful’, ‘.’], [‘That’, ‘said’, ‘,’, ‘I’, ‘am’, ‘wondering’, ‘what’, ‘are’, ‘the’, ‘availability’, ‘times’, ‘of’, ‘you’, ‘guys’, ‘?’], [‘I’, ‘can’, ‘meet’, ‘:’], [‘*Thursday’, ‘,’, ‘October’, ‘3rd*’, ‘,’, ‘with’, ‘lots’, ‘of’, ‘flexibility’, ‘.’], [‘*Friday’, ‘,’, ‘Oct.’, ‘4th*’, ‘as’, ‘of’, ‘3:30 PM’, ‘onward’], [‘*Monday’, ‘,’, ‘Oct.’, ‘7th*’, ‘post’, ‘2:00 pm’, ‘(,’, ‘I’, ‘have’, ‘a’, ‘dentist’, ‘appointment’, ‘in’, ‘the’, ‘morning’, ‘and’, ‘am’, ‘hoping’, ‘no’, ‘post-visit’, ‘effect’, ‘will’, ‘hinder’, ‘me’, ‘from’, ‘still’, ‘meeting’, ‘same’, ‘day’, ‘)’, ‘.’], [‘*Tuesday’, ‘,’, ‘Oct.’, ‘8th*’, ‘with’, ‘lots’, ‘of’, ‘flexibility’, ‘.’], [‘If’, ‘none’, ‘of’, ‘these’, ‘works’, ‘with’, ‘both’, ‘of’, ‘you’, ‘guys’, ‘,’, ‘please’, ‘go’, ‘ahead’, ‘and’, ‘suggest’, ‘some’, ‘slots’, ‘and’, ‘we’, “ll”, ‘make’, ‘it’, ‘happen’, ‘.’], [‘Ah’, ‘,’, ‘I’, ‘almost’, ‘forgot’, ‘.’], [‘Please’, ‘send’, ‘the’, ‘book’, ‘we’, ‘talked’, ‘about’, ‘last’, ‘week’, ‘to’, ‘John’, ‘and’, ‘buy’, ‘your’, ‘flight’, ‘tickets’, ‘asap’, ‘.’]], ‘NE_Positions’: [[[u′12′], [u′15′]], [[u′3′]], [[u′0′, u′1′], [u′9′]], [[u′01], [ ], [ ], [[u′2′, u′3′]], [[u′6′], [u′2′, u′3′]], [[u′5′, u′6′], [u′12′, u′13′, u′14′], [u′2′, u′3′]], [[u′2′, u′3′]], [ ], [ ], [[u′7′, u′8′], [u′10′]]], ‘NE_Terms’: [[‘Skype’, ‘http://www.apple.com’], [‘619 303 7288’ ], [‘John Doe’, ‘Skype’], [‘John’], [ ], [ ], [‘October 3rd*’], [‘3:30 PM’, ‘Oct. 4th*’], [‘2:00 pm (’, ‘in the morning’, ‘Oct. 7th*’], [‘Oct. 8th*’ ], [ ], [ ], [‘last week’, ‘John’]], ‘filtered_posSenteces’: [[ ], [ ], [ ], [ ], [ ], [ ], [ ], [ ], [ ], [ ], [ ], [ ], [ ]], ‘dependencies’: [ ], ‘raw_tokSenteces’: [‘I wanted to follow up on our last discussion with regard to Skype meeting at http://www.apple.com.’, ‘Call me at 619 333 2222.’, ‘John Doe and I are interested to chat via Skype.’, ‘John thought a meeting with the three of us is a good idea, which I also thought is useful.’, ‘That said, I am wondering what are the availability times of you guys ?’, ‘I can meet:’, ‘*Thursday, October 3rd*, with lots of flexibility.’, ‘*Friday, Oct. 4th* as of 3:30 PM onward’, ‘*Monday, Oct. 7th* post 2:00 pm (I have a dentist appointment in the morning and am hoping no post-visit effect will hinder me from still meeting same day).’, ‘*Tuesday, Oct. 8th* with lots of flexibility.’, “If none of these works with both of you guys, please go ahead and suggest some slots and we'll make it happen.”, ‘Ah, I almost forgot.’, ‘Please send the book we talked about last week to John and buy your flight tickets asap.’], ‘raw sentences’: [‘I wanted to follow up on our last discussion with regard to Skype meeting at http://www.apple.com.’, ‘Call me at 619 333 2222.’, ‘John Doe and I are interested to chat via Skype.’, ‘John thought a meeting with the three of us is a good idea, which I also thought is useful.’, ‘That said, I am wondering what are the availability times of you guys?’, ‘I can meet:’, ‘*Thursday, October 3rd*, with lots of flexibility.’, ‘*Friday, Oct. 4th* as of 3:30 PM onward’, ‘*Monday, Oct. 7th* post 2:00 pm (I have a dentist appointment in the morning and am hoping no post-visit effect will hinder me from still meeting same day).’, ‘*Tuesday, Oct. 8th* with lots of flexibility.’, “If none of these works with both of you guys, please go ahead and suggest some slots and we'll make it happen.”, ‘Ah, I almost forgot.’, ‘Please send the book we talked about last week to John and buy your flight tickets asap.’], ‘NE_Types’: [[‘MISC’, ‘URL’], [‘PHONE’], [‘LOC’, ‘ORG’], [‘PER’], [ ], [ ], [‘DATE’], [‘DATE’, ‘DATE’], [‘DATE’, ‘DATE’, ‘DATE’], [‘DATE’], [ ], [ ], [‘DATE’, ‘ORG’]]}), ‘body_quoting_text’: None, ‘reply_quoting_text’: None, ‘reply_quoted_text’: None, ‘reply_text’: None, ‘body_quoted_text’: None})

At 650, the analyzed email body is then passed to the speech act classifier module 208, which classifies each sentence into a predefined set of speech acts, as described in further detail above. Step 650 adds an additional field to the data structure outputted at step 640 that stores the speech act label assigned to each sentence in the email body. For example, “‘predicted_SPAs’: [5, 1, 5, 6, 3, 6, 6, 6, 1, 6, 1, 6, 1]” would be added to the first line of the output of step 640, as follows:
* * * defaultdict(<type ‘list’>, {‘body’: defaultdict(<type ‘list’>, {‘predicted_SPAs’: [5, 1, 5, 6, 3, 6, 6, 6, 1, 6, 1, 6, 1], ‘non_filtered_tokLemSentences’: * * *

At step 660, sentences identified as questions by the speech act classifier module 208 are fed into the questions classifier module 210, which classifies them into a predetermined set of question types. The input to the questions classifier module 210 are the sentences identified as questions in step 650. In the example above, questions have the speech act label “3.” So in the above example—‘predicted_SPAs’: [5, 1, 5, 6, 3, 6, 6, 6, 1, 6, 1, 6, 1]—there is only one question that would be passed to the questions classifier module. In this case, it would be:
[‘that’, ‘say’, ‘,’, ‘i’, ‘be’, ‘wonder’, ‘what’, ‘be’, ‘the’, ‘availability’, ‘time’, ‘of’, ‘you’, ‘guy’, ‘?’]

Step 660 adds an additional field to the data structure outputted by step 650 that stores the question type for sentences identified as questions. Using the example output above, the additional field—‘predicted_question_types’: [None, None, None, None, [‘qw’], None, None, None, None, None, None, None, None]—would be added as follows:
* * * ‘Ah, I almost forgot.’, ‘Please send the book we talked about last week to John and buy your flight tickets asap.’], ‘predicted_question_types’: [None, None, None, None, [‘qw’ ], None, None, None, None, None, None, None, None], ‘raw_sentences’: * * *

At step 670, tasks are identified and extracted by analyzing the output from steps 640-660. Step 670 adds two additional fields to the data structure outputted by step 660 that store information about whether a sentence is a fully parsed tasks or a task by discourse. Using the example output above, the additional fields—tasks': [[ ], [ ], [ ], [ ], [ ], [ ], [ ], [ ], [ ], [ ], [ ], [ ], [([(‘ACTION’, ‘send’), (‘IMPORTANCE’, ‘asap’), (‘RECIPIENT’, ‘to John’), (‘OBJECT’, ‘the book we talked about last week’)], (0.505822794901, 1.0, 0.7529113974505)), ([(‘ACTION’, ‘buy’), (‘OBJECT’, ‘your flight tickets’)], (0.8, 1.0, 0.9))]],—and—‘tasks_by_discourse’: [[‘I wanted to follow up on our last discussion with regard to Skype meeting at http://www.apple.com.’], [‘Call me at 619 333 2222.’], [‘John Doe and I are interested to chat via Skype.’], [ ], [ ], [ ], [ ], [ ], [‘*Monday, Oct. 7th* post 2:00 pm (I have a dentist appointment in the morning and am hoping no post-visit effect will hinder me from still meeting same day).’], [ ], [“If none of these works with both of you guys, please go ahead and suggest some slots and we'll make it happen.”], [ ], [ ]],—would be added as follows: defaultdict(<type ‘list’>, [‘body’: defaultdict(<type ‘list’>, {‘tasks’: [[ ], [ ], [ ], [ ], [ ], [ ], [ ], [ ], [ ], [ ], [ ], [ ], [([(‘ACTION’, ‘send’), (‘IMPORTANCE’, ‘asap’), (‘RECIPIENT’, ‘to John’), (‘OBJECT’, ‘the book we talked about last week’)], (0.505822794901, 1.0, 0.7529113974505)), ([(‘ACTION’, ‘buy’), (‘OBJECT’, ‘your flight tickets’)], (0.8, 1.0, 0.9))]], ‘predicted_SPAs’: * * * * * * ‘Please send the book we talked about last week to John and buy your flight tickets asap.’], ‘tasks_by_discourse’: [[‘I wanted to follow up on our last discussion with regard to Skype meeting at http://www.apple.com.’], [‘Call me at 619 333 2222.’], [‘John Doe and I are interested to chat via Skype.’], [ ], [ ], [ ], [ ], [ ], [‘*Monday, Oct. 7th* post 2:00 pm (I have a dentist appointment in the morning and am hoping no post-visit effect will hinder me from still meeting same day).’], [ ], [“If none of these works with both of you guys, please go ahead and suggest some slots and we'll make it happen.”], [ ], [ ]], ‘predicted_question_types’: * * *

Also at step 670, sentences classified as questions at step 650 and categorized into question types at step 660 are classified as actionable or non-actionable. Continuing the example output above, the additional field—‘actionable questions’: [0, 0, 0, 0, 1, 0, 0, 0, 0, 0, 0, 0, 0],—would be added as follows:
* * * ‘Oct. 7th*’], [‘Oct. 8th*’], [ ], [ ], [‘last week’, ‘John’]], ‘actionable_questions’: [0, 0, 0, 0, 1, 0, 0, 0, 0, 0, 0, 0, 0], ‘filtered_posSenteces’: [[ ], [ ], [ ], [ ], [ ], [ ], [ ], [ ], [ ], [ ], [ ], [ ], [ ]], ‘dependencies’: [ ], ‘raw_tokSenteces’: * * *

At step 680, output from step 670 is fed into the ranking linear regressor 212a, which ranks sentences using all the information contained in its input data structure to determine which sentences are most important and need to be added to the email summary and which sentence are not as important. At step 680, a scored ranking of sentences is generated for sentences contained in the email body. Continuing the example above, an exemplary output from step 680 is as follows:
[(0, (‘body’, 0), ‘I wanted to follow up on our last discussion with regard to Skype meeting at http://www.apple.com.’, 4.5402384922249688), (1, (‘body’, 0), ‘Call me at 619 333 2222.’, 2.0315334823419318), (2, (‘body’, 0), ‘John Doe and I are interested to chat via Skype.’, 3.240385097372469), (3, (‘body’, 0), ‘John thought a meeting with the three of us is a good idea, which I also thought is useful.’, 5.0569814490687977), (4, (‘body’, 0), ‘That said, I am wondering what are the availability times of you guys?’, 3.8649463480010371), (5, (‘body’, 0), ‘I can meet:’, 1.6395830771931899), (6, (‘body’, 0), ‘*Thursday, October 3rd*, with lots of flexibility.’, 2.8089722304496583), (7, (‘body’, 0), ‘*Friday, Oct. 4th* as of 3:30 PM onward’, 2.3778686594224423), (8, (‘body’, 0), ‘*Monday, Oct. 7th* post 2:00 pm (I have a dentist appointment in the morning and am hoping no post-visit effect will hinder me from still meeting same day).’, 6.4352431724163246), (9, (‘body’, 0), ‘*Tuesday, Oct. 8th* with lots of flexibility.’, 2.4542847146804627), (10, (‘body’, 0), “If none of these works with both of you guys, please go ahead and suggest some slots and we'll make it happen.”, 5.1582354036514744), (11, (‘body’, 0), ‘Ah, I almost forgot.’, 1.8063977721664872), (12, (‘body’, 0), ‘Please send the book we talked about last week to John and buy your flight tickets asap.’, 3.7886081204527402)]

At step 690, output from step 680 is fed into the post-processing rules module 212b that analyzes its input by applying a coherence-oriented set of rules to re-score the email body sentences and generate the final long and short summaries. Exemplary long and short email summaries output from step 690 are shown in FIGS. 5B and 5C, respectively.

At step 700, the one or more email summaries may be stored in email database 105 and/or output to the user. Similarly, the identified tasks, represented by fully parsed tasks, tasks by discourse, and actionable questions, may be stored in email database 105 and/or output to user, as explained in further detail above with respect to the tasks extractor module 214.

In accordance with exemplary embodiments of the invention, an email summary and/or a list of extracted tasks may be output and presented to a user (e.g., the email recipient). Based on the various modules used to create it, the email summary may represent a more coherent summary than prior art systems have achieved. The output of the disclosed method and system in the form of an email summary and/or extracted task list may simplify review and/or consumption of emails by the user, and may enable faster responses to such emails. The email summary and/or extracted task list may also enable automated responses, such as unsubscribing from an email distribution list or adding an event to the user's calendar, for example.

Embodiments of the disclosed invention are also useful in that review or “consumption” of email may be achieved more easily and more quickly on small screens than would otherwise be the case. Further, cleaning up an inbox may be achieved in a much more rapid pace than if the user had to review non-summarized emails, or emails without tasks extracted therefrom.

The disclosed method and system can be applied to a user's entire inbox or a portion thereof (e.g., only emails received after a certain date). A user may register with the email mining platform 101 by granting the email mining platform 101 access to the user's emails (as shown, for example, in FIG. 7), and/or by providing the user's name, email address, mail server (e.g., POP3, IMAP, Microsoft® Exchange, MAPI, Exchange ActiveSync), username, and password. Thereafter, the email mining platform 101 may access the user's email using, for example, user access tokens as defined in the oauth 2 protocol (see http://oauth.net/2/) and process all or a portion of the user's email inbox (as identified by the user). Such processing may implement the modules and/or sub-modules identified above for the purpose of summarizing emails and/or extracting tasks from the user's emails. The user's email may be processed and stored in email database 105, leaving the original email on the user's mail server.

The user may set up the email mining platform 101 to process emails as the user receives them. In other words, the user may decide wither to turn on or off the email mining platform with respect to that user's emails such that the user's emails are or are not processed. The email summaries 320 and/or tasks lists 330 may be sent to one or more user devices 110 via network 102, such as to an application on the user's smartphone, for example. The summaries 320 and/or task lists 330 may include a link to the original email 180 such that the original email can be viewed by the user upon clicking the link in the event the user wishes to review the original email. For example, a client may display an list of emails and if a user taps on an email thread from a classic list UI view, the user first sees a thread view where only summarized email messages (one or more) are displayed as summarized email messages. And if the user taps on a particular email message summary the original email message is displayed.

Hereinafter, physical aspects of implementation of the exemplary embodiments will be described. As described above, exemplary methods are computer-implemented carried out on a system. The system or portions of the system may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated.

It is appreciated that in order to practice the methods as described above, it is not necessary that the processors and/or the memories of the processing machine be physically located in the same geographical place. For example, each of the processors and the memories and the data stores used may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with further embodiments, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions. It is also appreciated that the data storage performed by two distinct components as described above may, in accordance with a further embodiment, be performed by a single component. Further, the data storage performed by one distinct component as described above may be performed by two distinct components.

Further, various technologies may be used to provide communication between the various processors and/or memories, as well as to allow the processors and/or the memories of the various embodiments to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of various embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the various embodiments may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments. Illustratively, the programming language used may include assembly language, ActionScript, Ada, APL, Basic, C, C++, C#, COBOL, Ceylon, Dart, dBase, F#, Fantom, Forth, Fortran, Go, Java, Jquery, Modula-2, .NET, Objective C, Opa, Pascal, Prolog, Python, REXX, Ruby, Visual Basic, X10, and/or JavaScript, for example. Further, it is not necessary that a single type of instructions or single programming language be utilized in conjunction with the operation of the system and method of various embodiments. Rather, any number of different programming languages may be utilized as is necessary or desirable.

Also, the instructions and/or data used in the practice of the various embodiments may utilize any compression or encryption technique or algorithm, as may be desired. An encryption module might be used to encrypt data. Further, files or other data may be decrypted using a suitable decryption module, for example.

As described above, various embodiments may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the system.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. A method for summarizing emails, comprising:
parsing, by an email zone identifier module, different zones in which an email is organized;
processing text within the email, the processing comprising:
tokenizing the text;
lemmatizing the text;
tagging the text with parts of speech;
analyzing syntactic dependencies within the text; and
extracting named entities;
classifying, by a speech act classifier module, each sentence of the text into one of a plurality of speech acts;
classifying, by a questions classifier module, sentences of the text that contain a question;
summarizing, by a conversational email summarizer module, the email into a compact and coherent summary, the summarizing comprising:
ranking each sentence in the text with an importance score, and adding sentences to an initial email summary that have an importance score surpassing a threshold; and
applying a set of post-processing rules to sentences in the initial email summary after ranking each sentence in the text to yield a final email summary; and
outputting the final email summary of the email.

2. The method of claim 1, further comprising classifying, by an email type classifier, the email as either conversational email or botmail.

3. The method of claim 1, wherein the different zones that are parsed for the email comprise a signature zone, a salutation zone, a body zone, and reply text.

4. The method of claim 1, wherein lemmatizing the text comprises removing inflectional endings of words in an email body zone and an earlier email zone, and returning the base or dictionary form of the words.

5. The method of claim 1, wherein the speech acts that are classified for each sentence comprise one of a command/request, commitment, questions, statement, desire/need, or miscellaneous speech act.

6. The method of claim 1, wherein the classifying, by the questions classifier module, the sentences of the text that contain a question, further comprises identifying a particular type of question within such sentences.

7. The method of claim 1, wherein ranking each sentence in the text is performed by a ranking linear regressor that assigns an importance score to each sentence in the text of a body zone of the email.

8. The method of claim 1, wherein the set of post-processing rules comprises an anaphora rule that identifies a sentence in the initial email summary that contains an anaphoric pronoun in initial words of the identified sentence, and if such an anaphoric pronoun is present, adding a second sentence to the final email summary, the second sentence being a sentence that is immediately prior to the identified sentence in an email body zone of the email.

9. The method of claim 1, wherein the set of post-processing rules comprises a discourse marker rule that identifies a sentence in the initial email summary that contains a discourse marker in initial words of the identified sentence, and if a discourse marker is present, adding a second sentence to the final email summary, the second sentence being a sentence that is immediately prior to the identified sentence in an email body zone of the email.

10. The method of claim 1, wherein the set of post-processing rules comprises a comparative adjective rule that identifies a sentence in the initial email summary that contains a comparative adjective, and if a comparative adjective is present, adding a second sentence to the final email summary, the second sentence being a sentence that is immediately prior to the identified sentence in an email body zone of the email.

11. The method of claim 1, wherein the set of post-processing rules comprises a questions rule wherein if a question-containing sentence is not in the initial email summary, adding the question-containing sentence to the final summary.

12. A system for summarizing emails, the system comprising:
one or more processors,
memory having instructions stored thereon, which when executed by the one or more processors, cause the processors to perform the following actions:
parsing different zones in which an email is organized;
tokenizing text within the email;
lemmatizing the text;
tagging the text with parts of speech;
analyzing syntactic dependencies within the text;
extracting named entities from the text;
classifying each sentence of the text into one of a plurality of speech acts;
classifying sentences of the text that contain a question;
summarizing the email into a compact and coherent summary, the summarizing comprising:
ranking each sentence in the text with an importance score, and adding sentences to an initial email summary that have an importance score surpassing a threshold; and
applying a set of post-processing rules to sentences in the initial email summary after ranking each sentence in the text to yield a final email summary; and
outputting the final email summary of the email.

13. The system of claim 12, the processors further performing the action of classifying the email as either conversational email or botmail.

14. The system of claim 12, wherein the different zones that are parsed for the email comprise a signature zone, a salutation zone, a body zone, and reply text.

15. The system of claim 12, wherein lemmatizing the text comprises removing inflectional endings of words in an email body zone and an earlier email zone, and returning the base or dictionary form of the words.

16. The system of claim 12, wherein the speech acts that are classified for each sentence comprise one of a command/request, commitment, questions, statement, desire/need, or miscellaneous speech act.

17. The system of claim 12, wherein classifying the sentences of the text that contain a question further comprises identifying a particular type of question within such sentences.

18. The system of claim 12, wherein ranking each sentence in the text comprises assigning an importance score to each sentence in the text of a body zone of the email.

19. The system of claim 12, wherein the set of post-processing rules comprises an anaphora rule that identifies a sentence in the initial email summary that contains an anaphoric pronoun in initial words of the identified sentence, and if such an anaphoric pronoun is present, adding a second sentence to the final email summary, the second sentence being a sentence that is immediately prior to the identified sentence in an email body zone of the email.

20. The system of claim 12, wherein the set of post-processing rules comprises a discourse marker rule that identifies a sentence in the initial email summary that contains a discourse marker in initial words of the identified sentence, and if a discourse marker is present, adding a second sentence to the final email summary, the second sentence being a sentence that is immediately prior to the identified sentence in an email body zone of the email.

21. The system of claim 12, wherein the set of post-processing rules comprises a comparative adjective rule that identifies a sentence in the initial email summary that contains a comparative adjective, and if a comparative adjective is present, adding a second sentence to the final email summary, the second sentence being a sentence that is immediately prior to the identified sentence in an email body zone of the email.

22. The system of claim 12, wherein the set of post-processing rules comprises a questions rule wherein if a question-containing sentence is not in the initial email summary, adding the question-containing sentence to the final summary.
